(19) United States
(12) Patent Application Publication
(10) Pub. No.: US 2025/0184069 A1
(43) Pub. Date: Jun. 5, 2025

(54) METHODS, APPARATUS, AND SYSTEM FOR MULTIPLE ACCESS

(71) Applicant: Huawei Technologies Co., Ltd., Shenzhen (CN)

(72) Inventors: Yu Cao, Kanata (CA); Jianglei Ma, Ottawa (CA); Huazi Zhang, Hangzhou (CN); Wen Tong, Ottawa (CA)

(21) Appl. No.: 19/047,513

(22) Filed: Feb. 6, 2025

Related U.S. Application Data
(63) Continuation of application No. PCT/CN2022/110773, filed on Aug. 8, 2022.

(51) Int. Cl. H04L 5/00; H04W 4/08

(52) U.S. Cl. CPC H04L 5/005; H04L 5/0053; H04W 4/08

(57) ABSTRACT

The present disclosure relates to communications between a network device and two or more apparatuses, in which the respective channels between the two or more apparatuses and the network device are correlated. In some aspects of the disclosure, a same demodulation reference signal may be assigned to two or more apparatuses, in which the respective channels between the two or more apparatuses and a network device are expected to be correlated. In some aspects, a network device may use a first multiple access scheme for two or more first apparatuses that are expected to have correlated channels, and a second multiple access scheme for a second apparatus.

### CROSS-REFERENCE TO RELATED APPLICATION

This application is a continuation of International Application No. PCT/CN2022/110773, filed on Aug. 8, 2022, the disclosure of which is hereby incorporated by reference in its entirety.

### TECHNICAL FIELD

This application relates to communication networks and, in particular, to communications between a network device and two or more apparatus in a communication network.

### BACKGROUND

As current and next generation networks support increasing numbers of electronic devices, non-orthogonal multiple access (NoMA) techniques are being proposed as an alternative to existing orthogonal multiple access techniques to improve network throughput. In NoMA, multiple devices may transmit on the same network resources (e.g., at the same time, at the same frequency and/or with the same spreading code), with different devices being distinguished by their power levels. Successive interference cancellation can be implemented at the receiver to separate the transmissions from the different devices.

An important use-case for NoMA is applications which rely on multiple devices (e.g., multiple sensors) communicating with the network. In these situations, the devices may be referred to as intra-user equipments (intra-UEs).

In one example use-case, a robot may include multiple devices connected to a communication network. The multiple devices may include one or more sensors and/or one or more control units. The one or more sensors may perform measurements (e.g., sensing) to collect information to be reported to the network. The one or more control units may receive instructions from the network and execute the instructions to cause the robot and/or the sensors to perform one or more operations.

In another example use-case, multiple devices may be used to monitor and/or manage the health of a patient. The devices may include one or more sensors for monitoring the patient (e.g., monitoring one or more vital signs of the patient and/or monitoring delivery of one or more drugs to the patient). The devices may, additionally or alternatively, include one or more management devices for providing healthcare to the patient (e.g., for delivering a drug to the patient).

In both of these examples, the multiple devices are likely to be in close proximity, which means the respective channels between the devices and the network device (e.g., a base station) may be the same or highly correlated. These are just two examples in which multiple devices are likely to have correlated channels due to being in close proximity. There are many other use-cases in which this situation may arise. In some examples, the devices may move together and keep the same relative channel characteristics. The devices may share a same transmitter and/or receiver radio frequency (RF) chain, or the devices may be provided with independent transmitter and/or receiver RF chains.

Whilst the close proximity of the devices means they may be served by a single beam from a network device, the correlation between their channels may make it prohibitively difficult for the network device to distinguish between transmissions from the different devices. For example, it may be difficult to use spatial multiplexing since successive interference cancellation techniques may not be sufficient to separate data received from different devices.

An alternative to NoMA would be to schedule transmissions by the multiple devices to ensure they do not occur at the same time or overlap in time. However, transmitting grants to the devices can increase signaling overhead. In addition, scheduled transmissions may not be suitable for low latency use-cases. For example, sensors in a robot may need to report sensing data and receive a response from the network with minimum delay to guarantee the accuracy of the operation of the robot. As a result, many use-cases implement grant-free transmission, in which transmission resources are configured in advance using higher layer signaling (e.g., similar to the configuration of a configured grant in 5G New Radio, NR, networks).

The situation may be further complicated by the devices (which may include sensing devices) having different data-arrival patterns. This means that the number of devices seeking to communicate with the network at any one time may vary. Some devices may not obtain data at predictable times, and thus it may appear that they are seeking to transmit to the network at random times. As many use cases require devices to report to the network with low latency, it may not be feasible to aggregate data for transmission at more predictable or regular intervals.

### SUMMARY

The present disclosure relates to communications between a network device and two or more apparatus, in which the respective channels between the two or more apparatus and the network device are correlated.

In some embodiments of the disclosure, a same demodulation reference signal (DMRS) may be assigned to two or more apparatus, in which the respective channels between the two or more apparatus and a network device are expected to be correlated. The two or more apparatus may be referred to as intra-User Equipments, or intra-UEs. In one example, the two or more apparatus may transmit the same DMRS to a network device. The two or more apparatus may transmit the same DMRS using the same network resources, for example. As such, the network device may receive a superposed DMRS which is made up of the same DMRS transmitted by each of the two or more apparatus. Rather, than trying to separate the DMRSs, the network device may use the superposed DMRS to demodulate signals received from the two or more apparatus.

This may be particularly advantageous in examples in which there are a large number of correlated apparatus, since existing techniques for generating and assigning DMRS may not yield enough orthogonal DMRS sequences for different DMRS to be transmitted by multiple apparatus. Using the same DMRS may further reduce the processing performed by the network device. Rather than calculating multiple channel estimates based on different DMRS received from different apparatus, the network device may calculate a shared channel estimate based on the combined DMRS received from multiple apparatus and use the shared channel estimate for demodulation of transmissions received from the multiple apparatus.

In another example, some but not all of the two or more apparatus may transmit, to the network device, a DMRS on behalf the two or more apparatus. Since the apparatus are expected to have similar channels, the network device may use the DMRS transmitted by some of the two or more apparatus to demodulate signals received from other apparatus in the two or more apparatus that did not transmit a DMRS. Though only some of the two or more apparatus transmit the DMRS, the channels for the two or more apparatus may still be estimated by the network device whilst minimizing resource usage. This can improve resource usage efficiency.

In some embodiments of the disclosure, a network device may use a first multiple access scheme for two or more first apparatus that are expected to have correlated channels, and a second multiple access scheme for a second apparatus. The second apparatus might not have a correlated channel. The two or more first apparatus may be referred to as intra-UEs. The second apparatus may be referred to as an inter-UE. Some multiple access techniques may not be suitable for apparatus which are highly correlated. For example, spatial domain separation may not be suitable for the two or more first apparatus since they have correlated channels, while techniques such as orthogonal code domain multiple access, time division multiple access and frequency division multiple access may be too resource intensive in embodiments in which the number of apparatus having correlated channels is large. However, these techniques may be suitable for other apparatus connected to the network device, such as the second apparatus. By using a first multiple access technique for apparatus having correlated channels and a second multiple access technique for other apparatus, network resources can be used more efficiently.

In a first aspect, the present disclosure provides a method performed by a network device. The method involves receiving a DMRS transmitted by one or more first apparatus in a plurality of apparatus, the plurality of apparatus having correlated channels. Each of the correlated channels are between a respective apparatus in the two or more apparatus and the network device. The method further involves receiving a signal transmitted by a second apparatus in the plurality of apparatus and demodulating the signal based on the DMRS. The one or more first apparatus include at least one apparatus that is different to the second apparatus.

In an example of the first aspect, the plurality of apparatus are determined to have correlated channels based on one or more of the following: respective locations of the plurality of apparatus; a channel correlation estimate for a first channel in the correlated channels and a second channel in the correlated channels; a measurement of a channel between one of the plurality of apparatus and another of the plurality of apparatus; and a difference in a measurement of the first channel and a measurement of the second channel.

In a further example of the previous example, the plurality of apparatus is determined to have correlated channels based on a comparison of the channel correlation estimate to a threshold.

In a further example of previous examples or first aspect, receiving the demodulation reference signal transmitted by the one or more first apparatus in the plurality of apparatus comprises receiving, from each of the plurality of apparatus, a same demodulation reference signa.

In a further example of previous examples or first aspect, receiving the demodulation reference signal transmitted by the one or more first apparatus in the plurality of apparatus comprises receiving the demodulation reference signal transmitted by a subset of apparatus in the plurality of apparatus on behalf of the plurality of apparatus.

In a further example of previous examples or first aspect, each apparatus in the plurality of apparatus is assigned a same group identifier and the demodulation reference signal is associated with the same group identifier.

In a further example of previous examples or first aspect, the method may further involve obtaining, for each apparatus in the plurality of apparatus, a respective identifier specific to the respective apparatus. Obtaining the respective identifier specific to the respective apparatus may involve receiving a transmission from the respective apparatus, and determining the respective identifier. The respective identifier may be determined based on one or more of the following: a codeword of the respective transmission, a modulation scheme used for the respective transmission, a power of the respective transmission.

A network device configured to perform the aforementioned method is also provided. In yet another aspect, a memory (e.g., a non-transitory processor-readable medium) is provided. The memory contains instructions (e.g., processor-readable instructions) which, when executed by a processor of a network device, cause the network device to perform the method described above.

In a second aspect, a method is provided. The method involves obtaining an indication of a plurality of first apparatus, each of the plurality of first apparatus having a respective first channel between a respective first apparatus and a network device. The method further involves indicating, based on a determination that the first channels are correlated, that the plurality of first apparatus are to transmit a same demodulation reference signal to the network device.

In an example of the second aspect, the method may further involve determining that the first channels are correlated based on one or more of the following. The determination may be based on one or more of the following: respective locations of the plurality of first apparatus, a channel correlation estimate for the first channels, a measurement of a channel between one of the plurality of first apparatus and another of the plurality of first apparatus, and a difference in a measurement of the first channels.

In a further example of the previous example or second aspect, the method may be performed by the network device. Alternatively, the method may be performed by a second apparatus. The method may further involve transmitting the same DMRS to the network device, based on a determination that a second channel between the second apparatus and the network device is correlated with at least one of the first channels.

An apparatus (e.g., an entity) configured to perform the aforementioned method is also provided. In yet another aspect, a memory (e.g., a non-transitory processor-readable medium) is provided. The memory contains instructions (e.g., processor-readable instructions) which, when executed by a processor of an apparatus, cause the apparatus to perform the method described above.

In a third aspect, a method is provided. The method involves indicating, to a first apparatus, a first parameter of a first multiple access scheme. The first multiple access scheme is for transmissions by the first apparatus and a second apparatus to a network device, in which a first channel between the first apparatus and the network device is correlated with a second channel between the second apparatus and the network device. The method further involves indicating, to a third apparatus, a second parameter of a second multiple access scheme for transmissions by the third apparatus to the network device.

In an example of the third aspect, the first channel and the second channel may be determined to be correlated based on one or more of the following: respective locations of the first apparatus and the second apparatus, a channel correlation estimate for the first channel and the second channel, a measurement of a third channel between the first apparatus and the second apparatus, a difference in a measurement of the first channel and a measurement of the second channel, and a difference in a measurement of the first channel and a measurement of the second channel. The method may further involve determining that the first channel is expected to be correlated with the second channel based on a comparison of the channel correlation estimate to a threshold.

In a further example of the previous example or third aspect, indicating the first parameter of the first multiple access scheme to the first apparatus may involve indicating a first codebook to the first apparatus and indicating the second parameter of the second multiple access scheme to the third apparatus may involve indicating a second codebook to the third apparatus. The second apparatus may be assigned the first codebook. The first codebook may include a plurality of non-linear orthogonal codes. Alternatively, the first codebook may include a plurality of linear orthogonal codes.

In a further example of the previous examples or third aspect, indicating the first parameter of the first multiple access scheme to the first apparatus may involve indicating a first transmission power to the first apparatus. The method may further involve indicating a second transmission power to the second apparatus. The second transmission power may be a second parameter of the first multiple access scheme.

The method may be performed by the network device. Alternatively, the method may be performed by the second apparatus. The method may further involve transmitting a signal to the network device with a second transmission power. The second transmission power may be a second parameter of the first multiple access scheme.

In a further example of the previous examples or third aspect, the method may further involve obtaining a first identifier for the first apparatus and a second identifier for the second apparatus. Indicating the first transmission power to the first apparatus may involve transmitting the first identifier to the first apparatus. Transmitting the signal to the network device may involve transmitting the signal to the network device with the second transmission power determined based on the second identifier.

An apparatus (e.g., an entity) configured to perform the aforementioned method is also provided. In yet another aspect, a memory (e.g., a non-transitory processor-readable medium) is provided. The memory contains instructions (e.g., processor-readable instructions) which, when executed by a processor of an apparatus, cause the apparatus to perform the method described above.

In a fourth aspect, a network device is provided. The network device includes a processor and a memory. The memory stores instructions which, when executed by the processor, cause the network device to receive a DMRS transmitted by one or more first apparatus in two or more apparatus expected to have correlated channels. Each of the correlated channels is between a respective apparatus in the two or more apparatus and the network device. The network device is further caused to receive a signal transmitted by a second apparatus in the two or more apparatus, and demodulate the signal based on the DMRS. The one or more first apparatus include at least one apparatus that is different to the second apparatus.

The two or more apparatus may be expected to have correlated channels based on one or more of: respective locations of the two or more apparatus, a channel correlation estimate for a first channel in the correlated channels and a second channel in the correlated channels, a measurement of a channel between one of the two or more apparatus and another of the two or more apparatus, and a difference in a measurement of the first channel and a measurement of the second channel. The two or more apparatus may be expected to have correlated channels based on a comparison of the channel correlation estimate to a threshold.

When the instructions are executed by the processor, the network device may be further caused to receive the DMRS transmitted by the one or more first apparatus in the two or more apparatus by receiving, from each of the two or more apparatus, a same DMRS.

When the instructions are executed by the processor, the network device may be further caused to receive the DMRS transmitted by the one or more first apparatus in the two or more apparatus by receiving the DMRS transmitted by a subset of apparatus in the two or more apparatus on behalf of the two or more apparatus.

Each apparatus in the two or more apparatus may be assigned a same group identifier. The DMRS may be associated with the same group identifier.

When the instructions are executed by the processor, the network device may be further caused to obtain, for each apparatus in the two or more apparatus, a respective identifier specific to the respective apparatus.

When the instructions are executed by the processor, the network device may be further caused to, for each apparatus in the two or more apparatus receive a transmission from the respective apparatus and determine a respective identifier specific to the respective apparatus. The respective identifier may be determined based on one or more of: a codeword of the respective transmission, a modulation scheme used for the respective transmission, and a power of the respective transmission.

In a fifth aspect, a first apparatus is provided. The first apparatus includes a processor and a memory. The memory stores instructions which, when executed by the processor, cause the first apparatus to obtain an indication of two or more second apparatus, in which each of the two or more second apparatus have a respective first channel between the respective second apparatus and a network device. The first apparatus is further caused to indicate, based on a determination that the first channels are expected to be correlated, that the two or more second apparatus are to transmit a same DMRS to the network device.

When the instructions are executed by the processor, the first apparatus may be further caused to determine that the first channels are expected to be correlated based on one or more of; respective locations of the two or more second apparatus, a channel correlation estimate for the first channels, a measurement of a channel between one of the two or more second apparatus and another of the two or more second apparatus, and a difference in a measurement of the first channel and a measurement of the second channel.

The first apparatus may include the network device.

When the instructions are executed by the processor, the first apparatus may be further caused to transmit the same DMRS to the network device, based on a determination that a second channel between the first apparatus and the network device is expected to be correlated with at least one of the first channels.

In a sixth aspect, a first apparatus is provided. The first apparatus includes a processor and a memory. The memory stores instructions which, when executed by the processor, cause the first apparatus to indicate, to a second apparatus, a first parameter of a first multiple access scheme, and indicate, to a fourth apparatus, a second parameter of a second multiple access scheme for transmissions by the fourth apparatus to a network device. The first multiple access scheme is for transmissions by the second apparatus and a third apparatus to a network device, in which a first channel between the second apparatus and the network device is expected to be correlated with a second channel between the third apparatus and the network device.

The first channel and the second channel may be expected to be correlated based on one or more of: respective locations of the second apparatus and the third apparatus, a channel correlation estimate for the first channel and the second channel, a measurement of a third channel between the second apparatus and the third apparatus, and a difference in a measurement of the first channel and a measurement of the second channel.

When the instructions are executed by the processor, the first apparatus may be further caused to determine that the first channel is expected to be correlated with the second channel based on a comparison of the channel correlation estimate to a threshold.

When the instructions are executed by the processor, the first apparatus may be further caused to indicate the first parameter of the first multiple access scheme to the second apparatus by indicating a first codebook to the second apparatus. The first apparatus may be further caused to indicate the second parameter of the second multiple access scheme to the fourth apparatus by indicating a second codebook to the fourth apparatus.

The third apparatus may be assigned the first codebook. The first codebook may include a plurality of non-linear orthogonal codes. The first codebook may include a plurality of linear orthogonal codes.

When the instructions are executed by the processor, the first apparatus may be further caused to indicate the first parameter of the first multiple access scheme to the second apparatus by indicating a first transmission power to the second apparatus.

When the instructions are executed by the processor, the first apparatus may be further caused to indicate a second transmission power to the third apparatus. The second transmission power may be a second parameter of the first multiple access scheme.

The first apparatus may include the third apparatus. When the instructions are executed by the processor, the first apparatus may be further caused to transmit a signal to the network device with a second transmission power. The second transmission power may be a second parameter of the first multiple access scheme.

When the instructions are executed by the processor, the first apparatus may be further caused to obtain a first identifier for the second apparatus and a second identifier for the first apparatus. The first apparatus may be further caused to indicate the first transmission power to the second apparatus by transmitting the first identifier to the second apparatus, and transmit the signal to the network device by transmitting the signal to the network device with the second transmission power determined based on the second identifier.

In a seventh aspect, a method performed by a first apparatus is provided. The method comprises transmitting a demodulation reference signal to a network device. The demodulation reference signal is for demodulating a signal transmitted by a second apparatus to the network device. The first apparatus and the second apparatus have correlated channels, where each of the correlated channels is between a respective first or second apparatus and the network device.

In an eighth aspect, a method performed by a first apparatus is provided. The method comprises transmitting information indicative of a channel between the first apparatus and a network device. The method further comprises receiving an indication to transmit a demodulation reference signal to the network device, the demodulation reference signal being a same demodulation reference signal transmitted by a second apparatus to the network device.

In a ninth aspect, a method performed by a first apparatus is provided. The method comprises receiving an indication of a first parameter of a first multiple access scheme. The first multiple access scheme is for transmissions by the first apparatus and a second apparatus to a network device. A first channel between the first apparatus and the network device is correlated with a second channel between the second apparatus and the network device. The first parameter of the first multiple access scheme is different from a second parameter of a second multiple access scheme indicated to a third apparatus, for transmissions by the third apparatus to the network device.

An apparatus (e.g., an entity) configured to perform the aforementioned methods is also provided. A computer-readable storage medium (e.g., a memory, a non-transitory processor-readable medium) with instructions to cause a computer to perform the aforementioned methods is also provided. A computer program product with instructions to cause a computer to perform the aforementioned methods is also provided. A processor of an apparatus configured to perform the aforementioned methods is also provided.

In a tenth aspect, a system is provided. The system comprises a network device, a first apparatus, and a second apparatus. The network device is configured to indicate, to a plurality of apparatus, each of the plurality of apparatus having a respective channel between a respective apparatus and the network device, that the channels are corrected. The first apparatus belongs to one of the plurality of apparatus. The first apparatus is in communication with the network device, and the first apparatus is configured to transmit a demodulation reference signal to the network device. The second apparatus belongs to one of the plurality of apparatus. The second apparatus is in communication with the network device, and the second apparatus is configured to transmit a same demodulation reference signal to the network device.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a communication system in which embodiments of the disclosure may occur.

FIG. 2 is another schematic diagram of a communication system in which embodiments of the disclosure may occur.

FIG. 3 is a block diagram illustrating units or modules in a device in which embodiments of the disclosure may occur.

FIG. 4 is a block diagram illustrating units or modules in a device in which embodiments of the disclosure may occur.

FIGS. 5-6 show signaling for methods according to embodiments of the disclosure.

FIG. 7 which shows a network device, a first electronic device and a second electronic device according to embodiments of the disclosure.

FIG. 8 shows an example of decoding an inner code according to embodiments of the disclosure.

FIG. 9 shows an example of a system according to embodiments of the disclosure.

FIG. 10 shows a flowchart of a method according to embodiments of the disclosure.

FIGS. 11 and 12 show constellation diagrams according to embodiments of the disclosure.

FIGS. 13-15 show flowcharts of methods according to embodiments of the disclosure.

### DETAILED DESCRIPTION

The operation of the current example embodiments and the structure thereof are discussed in detail below. It should be appreciated, however, that the present disclosure provides many applicable inventive concepts that can be embodied in any of a wide variety of specific contexts. The specific embodiments discussed are merely illustrative of specific structures of the disclosure and ways to operate the disclosure, and do not limit the scope of the present disclosure.

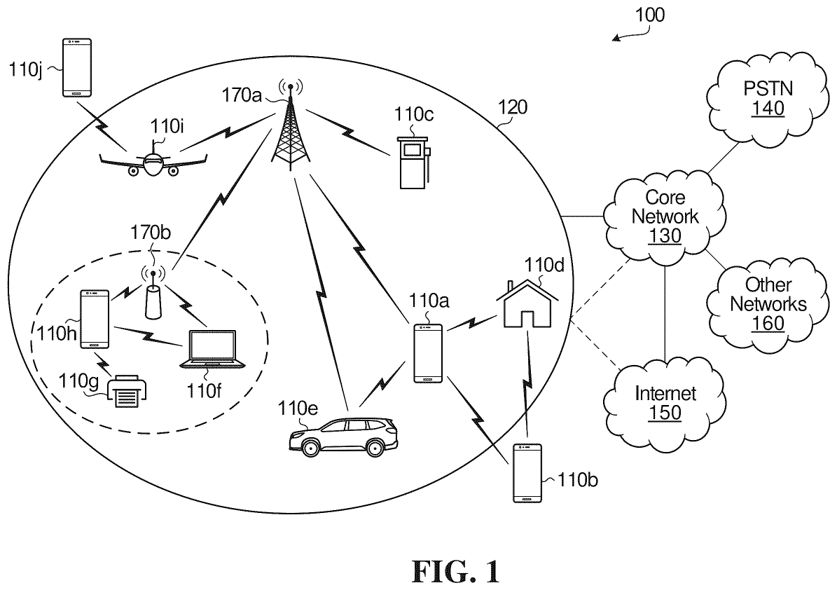

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electronic device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

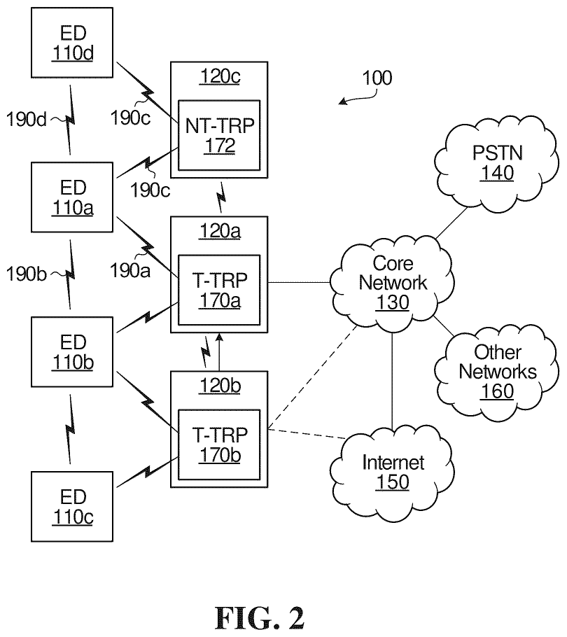

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANS 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

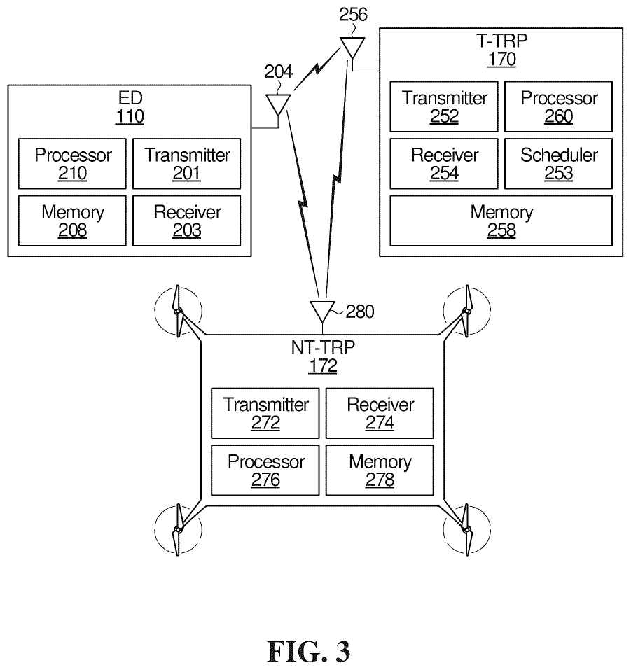

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

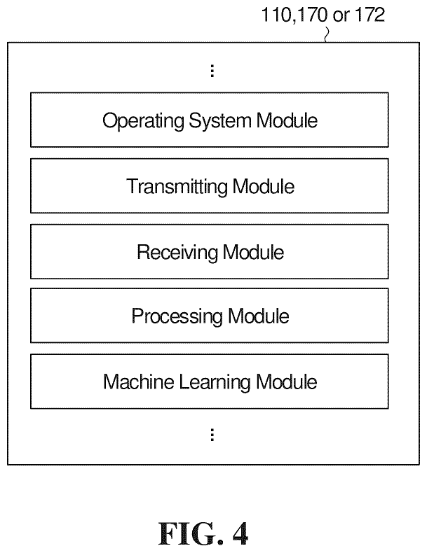

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

When apparatus that are close to one another are connected to a same network device (e.g., a same base station), the channels between the network device and the apparatus may be correlated (e.g., may be highly correlated). This can make it difficult for the network device to distinguish between transmissions from each of the apparatus since, for example, a successive interference cancellation receiver may not be able to separate data from the different apparatus when the channels are highly correlated. In addition, when the number of apparatus is large this can create difficulties for the transmission of reference signals from the apparatus to the network device. Typically, a plurality of apparatus connected to a network device will transmit demodulation reference signals (DMRSs) which are orthogonal, or nearly orthogonal, to one another to reduce the risk of collision (e.g., interference). However, methods for generating DMRSs provide only a limited number of orthogonal DMRSs, which means that, in some situations, the number of apparatus connected to a network device may exceed the number of orthogonal DMRSs that can be used.

According to aspects of the present disclosure, a same DMRS may be used for two or more apparatus for communications with a network device. The channels between the network device and the two or more apparatus are expected to be correlated (e.g., the channels are correlated, are determined to be correlated, and/or the two or more apparatus are co-located, so it is expected that the channels are correlated). In some embodiments, the two or more apparatus may transmit the same DMRS to the network device. In other embodiments, a subset of the two or more apparatus may transmit the DMRS on behalf of the two or more apparatus. Thus, the network device may use the DMRS received from one apparatus in the two or more apparatus to demodulate a signal received from another apparatus in the two or more apparatus.

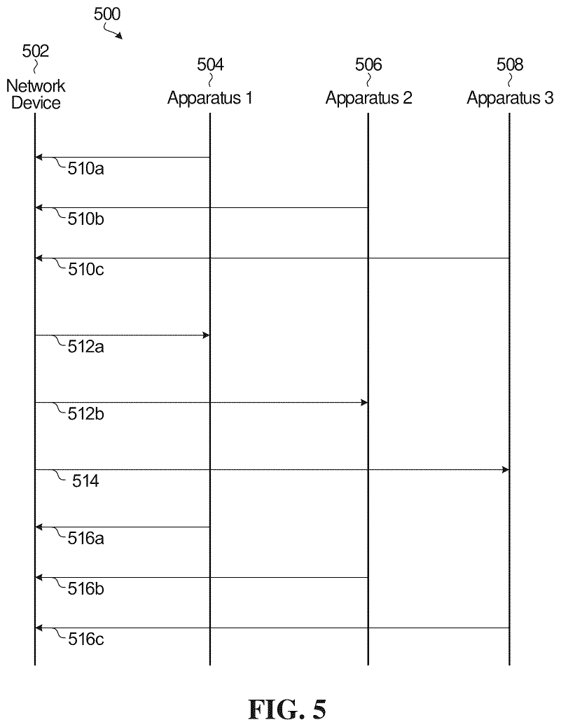

FIG. 5 shows signaling for a method 500 according to embodiments of the disclosure. The signaling is between a network device 502, a first apparatus 504, a second apparatus 506 and a third apparatus 508.

The network device 502 may a base station or TRP, such as one of the TRPs 170 described above in respect of FIGS. 1-4. The network device 502 may be in a radio access network (e.g., one of the radio access networks 120 described above in respect of FIGS. 1-4). The network device 502 may be operable to connect the apparatus 504-508 to a core network of a communication network (e.g., the core network 130 of the system 100).

Each of the first apparatus 504, second apparatus 506 and third apparatus 508 may be any suitable apparatus. The first apparatus 504, second apparatus 506 and third apparatus 508 might be a same type of apparatus or might be one or more different types of apparatus. In some embodiments, each of the first apparatus 504, second apparatus 506 and third apparatus 508 may be an electronic device, such as any of the electronic devices 110 described above in respect of FIGS. 1-4. One or more of the first apparatus 504, second apparatus 506 and third apparatus 508 may be sensing apparatus (e.g., may comprise one or more sensors).

Each of the first apparatus 504, second apparatus 506 and third apparatus 508 may comprise respective components for transmitting and receiving signals. As such, each apparatus 504, 506, 508 may be provided with a respective RF chain (e.g., an independent RF chain). In one example, each of the first apparatus 504, second apparatus 506 and third apparatus 508 may comprise a respective transmitter and a respective receiver coupled to one or more respective antennas. In another example, each of the first apparatus 504, second apparatus 506 and third apparatus 508 may comprise a respective transceiver coupled to one or more respective antennas.

The method 500 may begin with each of the first apparatus 504, second apparatus 506 and third apparatus 508 sending a respective configuration request 510a, 510b, 510c (collectively 510) to the network device 502. One or more of the configuration requests 510 (e.g., each of the configuration requests 510) may include data and/or network information. Thus, for example, each apparatus 502-508 may report network information, to the network device 502 in the respective configuration request 510. The network information received from a particular apparatus may comprise any suitable network information available to the respective apparatus such as, for example, one or more of: traffic information for the respective apparatus (e.g., a type, quantity and/or rate of traffic communicated by the respective apparatus), a location of the respective apparatus (e.g., as obtained by a Global Navigation Satellite System, GNSS, sensor at the respective apparatus), one or more channel measurements (e.g., a channel profile measurement), and sensing data. The sensing data may comprise data obtained from RF sensing, in which RF sensing may comprise transmitting one or more sensing signals (e.g., radio signals) and receiving a reflected signal comprising at least one reflection of the one or more sensing signals. The reflected signal may be used to infer information about the surroundings of the respective apparatus (e.g., the presence and/or position of one or more other apparatus).

There is a respective channel between each of the apparatus 504-508 and the network device 502. The network device 502 determines that the first channel, between the network device 502 and the first apparatus 504, and the second channel, between the network device 502 and the second apparatus 506, are expected to be correlated.

In some embodiments, the network device 502 may obtain a channel correlation estimate for the first and second channels and, based on the channel correlation estimate, determine that the first and second channels are expected to be correlated (e.g., are correlated). For example, the network device may determine that the channel correlation estimate is within a defined range or satisfies a threshold. For example, network device 502 may determine that the channel correlation estimate is greater than a threshold value.

The network device 502 may determine the channel correlation estimate based on a measurement of the first channel and a measurement of the second channel. The measurement of the first channel may comprise an estimate of the first channel at a first time. The measurement of the second channel may comprise an estimate of the second channel at a second time (e.g., the same or different to the first time).

The measurements may be performed by the first apparatus 504 and the second apparatus 506 respectively. Thus, for example, the network device 502 may receive the measurement of the first channel from the first apparatus 504 and the measurement of the second channel from the second apparatus 506. The first and second apparatus 504, 506 may perform the respective measurements on one or more reference signals (e.g., downlink reference signals such as, channel state information reference signals, CSI-RSs, or DMRSs) and/or data transmitted by the network device 502, for example. Alternatively, the measurements may be performed by the network device 502. The network device 502 may perform the measurements on one or more reference signals (e.g., uplink reference signals, such as sounding reference signals, SRS) and/or data transmitted by the first apparatus 504 and the second apparatus 506. In general, the one or more measurements may be performed on any suitable transmission received from the first apparatus 504 and/or the second apparatus 506 such as, for example, the configuration request, a scheduling request, a Physical Random Access Channel (PRACH) message and/or a Physical Uplink Shared Channel (PUSCH) message.

The channel correlation estimate may comprise a correlation coefficient. The network device 502 may determine the correlation coefficient using the measurements of the first channel and the second channel. Any suitable correlation coefficient may be used such as, for example, a Pearson product-moment correlation coefficient or a Spearman correlation coefficient. In some examples, the correlation coefficient of the first and second channels may take a value between −1 and 1. A large absolute value of the correlation coefficient (e.g., an absolute value that is close to 1) may indicate that the first and second channels are highly correlated. For example, a correlation coefficient equal to 1 may indicate that the first and second channels are maximally correlated, whereas a correlation coefficient equal to 0 may indicate that the first and second channels are completely uncorrelated. The network device 502 may determine that the first and second channels are expected correlated responsive to the correlation coefficient exceeding a threshold value. For example, the network device 502 may determine that the first and second channels are expected to be correlated responsive to the correlation coefficient exceeding (e.g., being greater than, or greater than or equal to) a threshold value of 0.9.

In some examples, the network device 502 may use the one or more measurements to determine complex channel coefficients h₁ and h₂ for the first and second channels respectively. The network device may determine the channel correlation estimate by determining the correlation coefficient of the complex channel coefficients h₁ and h₂ (e.g., in accordance with the steps described above).

The complex channel coefficients h₁ and h₂ may comprise one or more samples of the respective channels. The one or more samples may be at different times and/or frequencies (e.g., different subcarriers). The network device 502 may determine the channel correlation estimate based on multiple samples of the complex channel coefficients for the first and second channels (e.g., based on multiple samples of the first and second channels). In some examples, the network device 502 and the respective apparatus 504, 506 may comprise a plurality of transmit antennas and/or a plurality of receive antennas. The channel correlation estimate may be based on complex channel coefficients for each transmit-receive antenna pair. The channel estimate may be based on any of the correlation measure (e.g. correlation matrix) of the channel matrix of the first and second channels. Alternatively, the channel correlation estimate may be based on complex channel coefficients for equivalent channels after precoding.

The channel correlation estimate may account for large scale channel gain and/or small scale fading. In some examples, the channel correlation estimate may account for the absolute value of the large scale channel gain (e.g., the power gain including path loss) without accounting for the phase or small scale fading of the channel. For example, the network device may determine the channel correlation estimate by determining respective average powers (e.g., mean powers) of the channel gain for the first channel and the second channel, and estimating the ratio between the two average powers. The network device may determine the first and second channels are expected to be correlated responsive to determining that the ratio of the average powers satisfies a threshold value. For example, the ratio may comprise the smaller of the two average powers divided by the larger value of the two average powers and the network device 502 may determine that the first and second channels are expected to be correlated responsive to determining that the ratio is above a threshold value (e.g., a threshold value of 0.95 or 95%).

In some examples, the network device 502 may determine that the first and second channels are expected to be correlated based on a difference between the measurement of the first channel and the measurement of the second channel. The difference may be used in addition to or instead of the channel correlation estimate. Thus, in addition to or instead of determining a channel correlation estimate based on the measurements, the network device 502 may, for example, subtract one measurement from the other. The network device may determine that the first and second channels are expected to be correlated based on a determination that the difference satisfies a threshold (e.g., is less than a maximum value). For example, the network device 502 may determine that the first and second channels are expected to be correlated based on a determination that the measurement of the first channel differs from the measurement of the second channel by less than 10% (e.g., by 0.1). For example, the network device 502 may determine that the first and second channels are expected to be correlated based on a determination that the lesser of the measurement of the first channel and the measurement of the second channel is at least 0.9 (or 90%) of the greater of the measurement of the first channel and the measurement of the second channel.

In other examples, the network device 502 may determine that the first and second channel are expected to be correlated based on other measurements or parameters which may be indicative of the first and second channels being correlated. Thus, the network device 502 may determine that the first and second channels are expected to be correlated based on a channel correlation estimate, a difference between measurements of the first and second channels and/or one or more other factors. The one or more other factors may include, for example, one or more of: the respective locations of the first and second apparatus 504, 506, and a measurement of a channel between the first and second apparatus 504, 506, or any other suitable factors.

The skilled person will appreciate that there are many ways in which the respective locations of the first and second apparatus 504, 506 may be used to determine that the first and second channels are expected to be correlated. In some examples, the network device 502 may determine that the first and second channels are expected to be correlated by determining that the first apparatus 504 and the second apparatus 506 have a same or similar location (e.g., are co-located).

The network device 502 may, for example, determine that the first apparatus 504 and the second apparatus 506 are within a threshold separation (e.g., distance or signal travel time) of one another. The network device 502 may receive the locations of the first and second apparatus 504, 506 from the first and second apparatus 504, 506 respectively. Alternatively, the network device 502 may determine the respective locations of the first and second apparatus 504, 506 (e.g., based on measurements performed by the network device 502). For example, the network device 502 may determine the respective locations of the first and second apparatus 504, 506 based on respective angles of arrival (AoA) and/or signal strengths of signals received from the first and second apparatus 504, 506. In another example, the network device may receive a measurement of the separation between the first and second apparatus 504, 506 from at least one of the first apparatus 504 and the second apparatus 506 and make the determination based on the received measurement. For example, the first apparatus 504 may determine a separation (e.g., distance or signal travel time) between the first apparatus 504 and the second apparatus 506 by transmitting one or more sensing signals (e.g., radio signals) and receiving a reflection of at least one of the one or more sensing signals reflected by the second apparatus 506.

The network device 502 may determine that the first apparatus 504 and the second apparatus 506 have a same or similar location by determining that the first apparatus 504 and the second apparatus 506 form part of (e.g., are mounted on) a common entity (e.g., a system or body). The network device 502 may, for example, receive a respective indicator from each of the first apparatus 504 and the second apparatus 506 indicating a body that the respective apparatus forms a part of. The network device 502 may determine that the first and second apparatus 504, 506 form part of (e.g., are mounted on) a common entity based on a comparison of the indicators from the first apparatus 504 and the second apparatus 506. For example, the first and second apparatus 504, 506 may be sensors on a robotic system and the network device 502 may determine, based on indicators received from the first and second apparatus 504, 506, that the sensors form part of the same robotic system. In another example, the network device 502 may determine that the first and second apparatus 504, 506 are applied to a same patient (e.g., a human or animal body).

In some embodiments, the network device 502 may determine that the first and second channels are expected to be correlated responsive to using a same beam for the first and second apparatus 504, 506 (e.g., for transmissions to the first and second apparatus 504, 506 and/or reception of signals from the first and second apparatus 504, 506). Thus, in particular examples, the first and second apparatus may be covered by a same beam.

The network device 502 thus determines that the first and second channels are expected to be correlated. The network device 502 may make the determination based on any combination of the factors described above.

In some examples, the network device 502 may determine that the third channel, between the network device 502 and the third apparatus 508, is not expected to be correlated with one or more of the first channel and the second channel. The skilled person will appreciate that, in practice, it is likely that many channels will exhibit at least a small degree of correlation. Thus, in general, the third channel may be less correlated with the first and/or second channel than the first and second channel are with each other. This may mean that the third channel may be sufficiently different to the first and/or second channel that a channel estimate for the first channel or the second channel could not be used to for the third channel (e.g., for demodulation of signals received on the third channel) without risking or causing an impact on performance.

The determination that the third channel is not expected to be correlated with one or more of (e.g., both of) the first channel and the second channel may be based on one or more of the factors described above. For example, the third apparatus 508 may be a sufficient distance from the first and/or second apparatus 504, 506 (e.g., may be separated from the first and/or second apparatus 504, 506 by a minimum distance). In another example, an estimate of the channel correlation between the third channel and one or more of the first and second channels may be below a threshold value. In another example, the first and second apparatus 504, 506 may form part of or be mounted on a common entity and the third apparatus 508 might not form part of or be mounted on the common entity.

Since the first channel and second channel are expected to be correlated, the first and second apparatus 504, 506 may be referred to as correlated apparatus. The third apparatus may be referred to as an uncorrelated apparatus. In some examples, the first and second apparatus 504, 506 may be referred to as intra-user equipments (intra-UEs). The third apparatus 508 may be referred to an inter-user equipment (inter-UE).

The network device 502 may thus determine that the first apparatus 504 and second apparatus 506 are correlated apparatus (or intra-UEs).

Based on the determination that the first and second channels are expected to be correlated, the network device 502 sends a respective message 512a, 512b to the first and second apparatus 504, 506 indicating that the first and second apparatus 504, 506 are to transmit a same DMRS to the network device 502. The skilled person will be familiar with DMRSs, so they will not be discussed here in detail. Briefly, a DMRS may be a reference signal (e.g., a signal known to both the transmitter and the receiver) which may be used by a receiver to produce a channel estimate for demodulation of signals received from a transmitter (e.g., to extract information-bearing signals from the received signals). The same DMRS may be a same sequence (e.g., a same Zadoff-Chu sequence or a same Gold sequence) that is to be transmitted by both the first apparatus 504 and the second apparatus 506. The same DMRS may, for example, be the same sequence to be transmitted by the first and second apparatus 504, 506 on the same time-frequency resources. The same DMRS may equivalently be referred to as the common DMRS.

The network device 502 may include any suitable indicator in the messages 512a, 512b to indicate that the first and second apparatus 504, 506 are to transmit a same DMRS. The messages 512a, 512b may include the same DMRS, for example. In another example, the network device 502 may indicate that the first and second apparatus 504, 506 are to transmit a same DMRS by sending, in the messages 512a, 512b (collectively 512) a common identifier (e.g., a group identifier, a common identity or ID) for the first and second apparatus 504, 506. The common identifier may be same for the first apparatus 504 and the second apparatus 506. The common identifier may be referred to as an intra-UE ID, for example. The intra-UE ID may identify the group of intra-UEs (e.g., the first and second apparatus 504, 506). The same DMRS may be derivable (e.g., by the first and second apparatus 504, 506) from the common identifier such that the common identifier may be used to indicate the same DMRS.

The network device 502 sends a message 514 to the third apparatus 508 indicating that the third apparatus 508 is to transmit another DMRS to the network device. The other DMRS is different to the same DMRS (e.g., different to the DMRS to be transmitted by the first and second apparatus 504, 506). In some examples, the other DMRS may be orthogonal to the same DMRS.

The first apparatus 504, second apparatus 506 and third apparatus 508 transmit DMRSs 516a, 516b, 516c to the network device 502. The first apparatus 504 and the second apparatus 506 transmit the same DMRS 516a, 516b (e.g., as indicated in the messages 512a, 512b). The third apparatus 508 transmits the other DMRS 516c (e.g., as indicated in the message 512c).

The first and second apparatus 504, 506 may transmit the same DMRS to the network device 502 synchronously (e.g., at the same time and/or such that they arrive at the network device 502 at the same time). The first and second apparatus 504, 506 may transmit the same DMRS 516a, 516b using the same network resources (e.g., using the same one or more time-frequency resources). The first and second apparatus 504, 506 may transmit the same DMRS 516a, 516b using one or more time-frequency resources at one or more symbols at the beginning of a subframe or slot. In some examples, instead of transmitting the same DMRS, the first and second apparatus 504, 506 may transmit the same preamble 516a, 516b using one or more time-frequency resources at one or more symbols at the beginning of a subframe or slot. In some examples, the first and second apparatus 504, 506 may transmit the same DMRS 516a, 516b using one or more time-frequency resources at one or more symbols in the middle of a subframe or slot.

The first and second apparatus 504, 506 may be preconfigured to transmit the same DMRS using the same network resources. Alternatively, the network device 502 may indicate, to the first and second apparatus 504, 506, the same one or more network resources to be used for transmission of the same DMRS. For example, the network device 502 may indicate the same one or more network resources in the messages 512a, 512b. The messages 512a, 512b may thus indicate a particular time (e.g., one or more symbols) and/or frequency (e.g., one or more subcarriers) at which the same DMRS is to be transmitted.

The network device 502 thus receives the same DMRS 516a, 516b from the first and second apparatus 504, 506 (e.g., as a combined or superposed signal). The network device 502 may further determine a same channel estimate for the first and second channel based on one or more measurements performed on the same DMRS 516a, 516b. Rather than seeking to distinguish between the same DMRS 516a received from the first apparatus 504 and the same DMRS 516b received from the second apparatus 506, the network device 502 may use the combined signal received from both the first apparatus 504 and the second apparatus 506 to estimate the first and second channels. Since the first and second channels are expected to be correlated, a single channel estimate based on the combined same DMRS received from both the first and second apparatus 504, 506 may be used to capture the conditions of both channels.

The network device 502 may further receive data from the first and/or second apparatus 504, 506. The first and/or second apparatus 504, 506 may transmit the data with the respective DMRS 516a, 516b (e.g., in a same message). Alternatively, the first and/or second apparatus 504, 506 may transmit the data separately to the respective DMRS 516a, 516b (e.g., in different a message). The network device 502 may demodulate the data received from the first and/or second apparatus 504, 506 based on the same channel estimate. Thus, the combined DMRS 516a, 516b may be used for demodulation of data transmitted by the first and/or second apparatus 504, 506.

The network device 502 may further determine a channel estimate for the third channel (e.g., between the network device 502 and the third apparatus 508) based on the other DMRS 516c. The network device 502 may further receive data from the third apparatus 508. The third apparatus 508 may transmit the data with the other DMRS 516c (e.g., in the same message). Alternatively, the third apparatus 508 may transmit the data separately to the other DMRS 516c (e.g., in different a message). The network device 502 may demodulate the data received from the third apparatus 508 based on the channel estimate for the third channel.

### Common Identifier

As described above, the network device 502 may indicate that the first and second apparatus 504, 506 are to use a same DMRS by sending a common identifier to the first and second apparatus 504, 506. In other embodiments, the network device 502 might assign and/or indicate a common identifier to the first and second apparatus 504, 506 without indicating that the first and second apparatus are to transmit a same DMRS. By assigning a common identifier to the first and second apparatus 504, 506, the network device 502 may treat the first and second apparatus 504, 506 as belonging to a single logic node identified by the common identifier. Thus, from the perspective of the network device 502, a logic node may be shared by the first and second apparatus 504, 506. Thus, although the common identifier may be used to derive a common DMRS in some embodiments, its use is not limited as such. In some embodiments, the common identifier may be used to generate or select a channel for initial access (e.g., in addition to, or instead of, indicating a same DMRS). For example, the common identifier may be used by the first and second apparatus 504, 506 to select a common (e.g., shared) access channel, such as a random access channel (RACH). In another example, the common identifier may be used to select a preamble sequence to be transmitted in physical random access channel (PRACH) in initial access.

### Common Configuration

In general, the network device 502 may indicate a common configuration to the first apparatus 504 and the second apparatus 506 (e.g., in the messages 512a, 512b). The common configuration may include the common DMRS, one or more network resources to be used for transmitting the common DMRS and/or the common identifier (e.g., the intra-UE ID) described above.

Additionally or alternatively, the common configuration may include one or more of: a time-frequency resource configuration, a modulation and coding scheme (MCS), one or more power control parameters, a timing advance (e.g., for synchronization), a beam configuration (e.g., a multiple input multiple output, MIMO, configuration), and a grant-free configuration to be used by the first apparatus 504 and the second apparatus 506 for communications with (e.g., transmissions to) the network device 502. One or more of these parameters may be common to the first apparatus 504 and the second apparatus 506 and thus may be signaled to the first and second apparatus 504, 506 as part of the common configuration.

The time-frequency resource configuration may indicate one or more time-frequency resources for the first and second apparatus 504, 506 to use. The one or more time-frequency resources may include a pool of time-frequency resources (e.g., a plurality of time-frequency resources) for the first and second apparatus 504, 506 to select one or more time-frequency resources from.

The time-frequency resources indicated by time-frequency resource configuration may include time-frequency resources that are used periodically. Thus, the time-frequency resources may be indicated by a periodicity and a time offset for each period defined by the periodicity. The periodicity may indicate a time interval between subsequent time-frequency resources indicated by the time-frequency resource configuration. The time-frequency offset may define one or more time-frequency resources in a respective period (e.g., one or more symbols and/or one or more resource blocks to be used for transmissions). The time offset may thus indicate the time location of a transmission in one of the periods defined by the periodicity. For example, the time offset may indicate a slot number with respect to frame o (e.g., system frame number, SNF, =0) of a system.

The one or more power control parameters may include one or more parameters that first and second apparatus 504, 506 can used to derive an uplink transmission power (e.g., a power to be used for transmissions to the network device 502). The first and second apparatus 504, 506 may thus be configured to determine an uplink transmission power based on the one or more power control parameters in addition to, for example, a path loss for the respective apparatus 504, 506 and/or one or more other measurements.

The time-frequency resource configuration and/or the one or more power control parameters may be part of a grant-free configuration. This is described in further detail below. Alternatively, the time-frequency resource configuration and/or the one or more power control parameters may be a separate configuration that is not part of the grant-free configuration.

The timing advance (TA) is a time offset (e.g. an advance of time duration) that a respective apparatus is to apply to its uplink transmission with respect to a downlink frame such that it is synchronized with other apparatus. The timing advance may thus include a negative time offset between the start of a downlink subframe received at the respective apparatus and an uplink subframe transmitted by the respective apparatus. According to embodiments of the disclosure, the first and second apparatus 504, 506 may be assigned the same timing advance. As such, the timing advance for the first and second apparatus 504, 506 may form part of the common configuration.

Beam configuration may include one or more of: a beam direction (e.g., a specific beam direction), a precoder or any other MIMO-related transmission parameters. The beam configuration may be used by the first and/or second apparatus 504, 506 to transmit a signal using specific beam. Thus, the first and second apparatus may be configured to use the same beam for uplink and/or downlink transmissions.

The skilled person will be familiar with grant-free transmission, so it will not be discussed in detail here. Briefly, grant-free transmission may refer to be transmissions (e.g., by the first apparatus 504 and/or the second apparatus 506) without receiving a dynamic grant (e.g., without receiving a grant explicitly allocating network resources for a particular transmission). Grant-free transmission may equivalently be referred to as grant-less transmission, autonomous transmission, or configured-grant transmission. In some examples, the method 500 may be implemented in an NR network and the grant-free configuration may comprise the configuration for a configured-grant transmission as defined for NR networks.

The common configuration may thus include a grant-free configuration for configuring the first apparatus 504 and/or the second apparatus 506 to transmit to the network device 502 without waiting to receive dynamic grants from the network device 502. By enabling the first and second apparatus 504, 506 to perform grant-free transmission without receiving a dynamic grant for the transmission, delay and signaling overhead can be reduced.

The grant-free configuration may include one or more of: a time-frequency resource configuration, a modulation and coding scheme and the one or more power control parameters described above. Alternatively, one or more of: a time-frequency resource configuration, a modulation and coding scheme and the one or more power control parameters may form part of a separate configuration that is not part of the grant-free configuration.

The common configuration may be signaled to the first and second apparatus 504, 506 using higher layer signaling. For example, the common configuration may be signaled to the first and second apparatus 504, 506 using RRC signaling (e.g., UE-specific RRC signaling). The common configuration may alternatively be signaled to the first and second apparatus 504, 506 using physical layer signaling such as downlink control information (DCI) signaling. In some examples, the common configuration may be signaled (e.g., transmitted) to the first and second apparatus 504, 506 by the network device 502 using a combination of higher layer and physical layer signaling.

In some examples, the network device 502 may transmit the common configuration to the first and second apparatus 504, 506 using group signaling that targets all apparatus sharing the common identifier (e.g., all apparatus belonging to a same intra-UE ID). The group signaling may comprise group-common RRC signaling or group-common DCI, for example.

Thus the network device 502 may indicate a common configuration to the first apparatus 504 and the second apparatus 506 (e.g., in the messages 512a, 512b), in which the common configuration may include one or more of: the common DMRS, one or more network resources to be used for transmitting the common DMRS, the common identifier, a time-frequency resource configuration, an MCS, one or more power control parameters, a timing advance, a beam configuration, and a grant-free configuration to be used by the first apparatus 504 and the second apparatus 506 for communications with the network device 502.

By using a common configuration for multiple apparatus, the method 500 can reduce processing at the network device 502 and reduce signaling used to configure the apparatus. This reduces the configuration overhead.

### Apparatus-Specific Configuration

In some embodiments, the network device 502 may additionally indicate a respective apparatus-specific configuration to each of the first apparatus 504, second apparatus 506 and third apparatus 508. The apparatus-specific configurations may differ from the common configuration.

The apparatus-specific configuration for a respective apparatus may include an apparatus-specific identifier (e.g., an apparatus identity or ID). The apparatus-specific identifier may differ from the common identifier discussed above. The common identifier may be used to identify the group of the first apparatus 504 and the second apparatus 506, whereas the respective apparatus-specific identifiers for the first and second apparatus 504, 506 may be used to identify (e.g., uniquely identify) the first and second apparatus 504, 506 respectively. In examples in which the apparatus 504-508 are sensors, the apparatus-specific identifier may be referred to as a sensor-specific identifier (e.g., sensor-specific identity or ID).

The apparatus-specific identifier may be for scrambling of data. The apparatus-specific identifier may be for performing a cyclic redundancy check (CRC) scrambling. The apparatus-specific identifier may be for addressing control channel. For example, the apparatus-specific identifier may be an apparatus-specific (e.g., UE-specific) Radio Network Temporary Identifier (RNTI). The apparatus-specific identifier may have similar functionality to a cell RNTI (C-RNTI) defined in the Long Term Evolution (LTE) or NR standards.

The apparatus-specific identifier may be used to address the control channel that is sent to the respective apparatus 504-508. For example, the apparatus-specific identifier may define the search space of a DCI. The apparatus-specific identifier may be used to scramble the CRC of the DCI. The apparatus-specific identifier may, additionally or alternatively, be used to scramble one or more uplink data transmissions on a physical uplink shared channel (PUSCH), one or more downlink data transmissions on a physical downlink shared channel (PDSCH), and/or to scramble the data payload of a DCI sent to the respective apparatus 504-508 (e.g., from the network device 502).

The apparatus-specific identifier may be related to a transmission parameter for the apparatus. For example, the apparatus-specific identifier may relate to a parameter of a multiple access scheme to be used by the respective apparatus (e.g., as described below in respect of multiple access methods). The transmission parameter may include one or more of: a codeword, a signature, a power (e.g., a transmission power) and a modulation scheme (e.g., a modulation and coding scheme). As such, recipients of transmissions from a respective apparatus may be able to identify the apparatus that sent the transmission based on the transmission parameter (e.g., without the apparatus-specific identifier being explicitly included in the transmission). For example, the network device 502 may be able to identify a transmission from the first apparatus 504 based on a codeword used by the first apparatus 504.

In some examples, the apparatus-specific identifier may be a parameter to be included in transmissions. An apparatus may, for example, include the apparatus-specific identifier in its transmissions (e.g., in a header) to allow the apparatus to be identified. For example, the network device 502 may receive a transmission, decode the transmission (e.g., without knowing the identity of the transmitter), and, based on the decoded data, determine the transmission was sent by the first apparatus 504.

In addition to or instead of the apparatus-specific identifier, the apparatus-specific configuration may include one or more of: a common identifier (e.g., the intra-UE entity ID), a time-frequency resource configuration, a modulation and coding scheme (MCS), one or more power control parameters, a timing advance (e.g., for synchronization), a beam configuration (e.g., a multiple input multiple output configuration), and a grant-free configuration. The parameters are described above in respect of the common configuration.

The network device 502 may indicate the apparatus-specific configurations to the first apparatus 504, second apparatus 506 and third apparatus 508 in the respective messages 512a, 512b and 512c. Alternatively, the network device 502 may indicate the common configuration for the first apparatus 504, second apparatus 506 separately to the respective apparatus-specific configurations. For example, the network device 502 may broadcast an indication of the common configuration (e.g., to be received by the first and second apparatus 504, 506). The network device 502 may use a one-to-many transmission to indicate the common configuration to the first and second apparatus 504, 506 and one-to-one transmissions to indicate the apparatus-specific configurations for the apparatus 504-508.

In some embodiments, the network device 502 might not indicate some or all of the apparatus-specific configurations to the apparatus 504-508. For example, the network device 502 might not indicate apparatus-specific configurations to the first and second apparatus 504, 506 (e.g., might only indicate the common configurations to the first and second apparatus 504, 506). In these examples, some or all of the apparatus 504-508 may be preconfigured with the respective apparatus-specific configurations. Alternatively, some or all of the apparatus 504-508 may determine the respective apparatus-specific configurations. For example, one or more of the apparatus 504-508 might determine one or more apparatus-specific configuration parameters based on a predefined relationship and one or more parameters (e.g., measured or known parameters). In another example, one or more of the apparatus 504-508 might select one or more apparatus-specific configuration parameters at random.

The common configuration and/or the apparatus-specific configurations may be indicated using Radio Resource Configuration (RRC) signaling (e.g., during configuration of connected or inactive states via RRC signaling) or initial access signaling. For example, the common configuration may be indicated (e.g., broadcast) using RRC or initial access signaling. The apparatus-specific configurations may be indicated using RRC signaling. In one example, some or all of the first, second and third messages, 512a, 512b, 514 may comprise an RRC Connection Setup message or an RRC Connection Reconfiguration message. In another example, some or all of the first, second and third messages, 512a, 512b, 514 may comprise a Random Access message, such as a Random Access Response message (e.g., a message sometimes referred to as “msg2”).

In the above description of the method 500, there are three apparatus 506-508. In general, the method 500 may be applied to other numbers of apparatus. In some embodiments, the third apparatus 508 may be omitted. In some embodiments, there may be more than two apparatus that are expected to have correlated channels. In general, the method 500 may be performed in respect of two or more apparatus that are expected to have correlated channels.

Aspects of the present disclosure thus provide a method in which apparatus that are expected to have correlated channels (e.g., correlated apparatus) may transmit a same DMRS to a network device 502. This may be particularly advantageous in examples in which there are a large number of correlated apparatus, since existing techniques for generating an assigning DMRS may not yield enough orthogonal DMRS sequences for different DMRS to be transmitted by multiple apparatus. Using the same DMRS may further reduce the processing performed by the network device. Rather than calculating multiple channel estimates based on different DMRS received from different apparatus, the network device may calculate a shared channel estimate based on the combined DMRS received from multiple apparatus and use the shared channel estimate for demodulation of transmissions receives from the multiple apparatus.

### Transmission of DMRS on Behalf of Another Apparatus

In the above description of the method 500, the first apparatus 504 and the second apparatus 506 transmit the same DMRS to the network device 502. In other embodiments, one of the first and second apparatus 504, 506 may transmit a DMRS on behalf of both the first and second apparatus 504, 506. Thus, a same DMRS may be assigned to both the first apparatus 504 and the second apparatus 506 (e.g., by the network device 502), but it may be transmitted by only one of the first apparatus 504 and the second apparatus 506. The network device 502 may use the DMRS transmitted by one of the first and second apparatus 504, 506 to demodulate signals from the other of the first and second apparatus 504, 506 (e.g., in addition to using the DMRS to demodulate signals received from the one of the first and second apparatus 504, 506). The signals may comprise data and/or control information (e.g., one or more reference signals or network information), for example. As the first and second channels are expected to be correlated, a channel estimate based on a DMRS transmitted by one of the first and second apparatus 504, 506 should sufficiently characterize both the first channel and the second channel. By only one of the first and second apparatus 504, 506 transmitting the DMRS, the first and second channel may still be estimated whilst minimizing resource usage.

This approach may be extended to more apparatus that are expected to have correlated channels. In general, a subset of two or more apparatus may transmit a DMRS on behalf of the two or more apparatus. In examples in which the subset includes at least two apparatus (e.g., the DMRS is transmitted by multiple apparatus), the same DMRS may be transmitted by the subset of apparatus (e.g., in accordance with the transmission of the same DMRS described above in respect of the method 500). In some scenarios, all apparatus that are expected to have correlated channels may transmit the same DMRS.

Determining that the Channels are Expected to be Correlated

In the above description of the method 500, the network device 502 determines that the first and second apparatus 504, 506 are expected to have correlated channels. In other embodiments, the determination may be made elsewhere (e.g., the network device 502 may not know that the apparatus 504, 506 are expected to have correlated channels). In some embodiments, the network device 502 may determine, based on receiving a same DMRS from the first and second apparatus 504, 506, that the first and second apparatus 504, 506 are expected to have correlated channels. The network device 502 may determine, based on receiving a same DMRS from the first and second apparatus 504, 506, that the first and second apparatus 504, 506 have a same or similar location (e.g., are co-located). The network device 502 may determine a common identifier for the first and second apparatus 504, 506 based on the same DMRS received from the first and second apparatus 504, 506 (e.g., since the DMRS may be derivable from the common identifier). The network device 502 may thus determine that the first and second apparatus 504, 506 belong to a logic node (a single logic node) responsive to receiving the same DMRS from the first and second apparatus 504, 506.

In some examples, the determination that the first and second apparatus 504, 506 are expected to have correlated channels may be based on receiving the same DMRS on one or more particular time-frequency resources. For example, the same DMRS sequence may be assigned to multiple groups of apparatus. Each of the apparatus in a respective group may be expected to have correlated channels. Each group may be assigned respective time-frequency resources for DMRS transmission, such that the network device 502 may identify a received DMRS as being transmitted by particular group of apparatus from the time-frequency resources used for the transmission.

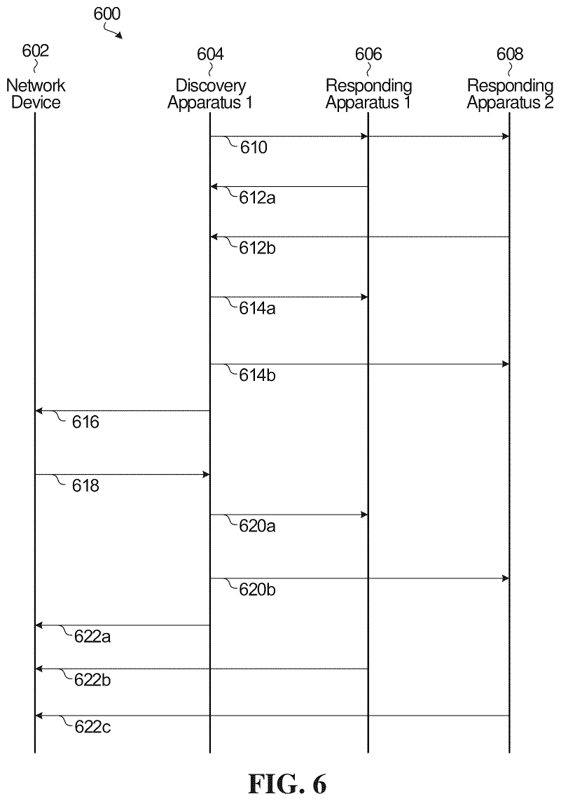

The skilled person will appreciate that the determination that the first and second apparatus 504, 506 are expected to have correlated channels may be made at any suitable entity. In one example, the first and second apparatus 504, 506 may be connected to two network devices (e.g., in dual connectivity) including the network device 502 and the other network device may configure the first and second apparatus 504, 506 to transmit the same DMRS. In some examples, a group of apparatus (e.g., a group of electronic devices) that are expected to have correlated channels may be configured to transmit a same DMRS by one of the apparatus in the group. For example, one of the first and second apparatus 504, 506 may configure both the first and second apparatus 504, 506 to transmit the same DMRS. An example embodiment of one of the correlated apparatus configuring one or more other correlated apparatus with a common configuration (such as a same DMRS) is described in more detail below in respect of FIG. 6.

FIG. 6 shows signaling for a method 600 according to embodiments of the disclosure. The signaling is between a network device 602, a discovery apparatus 604 (or leader apparatus), a first responding apparatus 606 and a second responding apparatus 608 (the apparatus 604-608 collectively).

Although the apparatus 604 is referred to as the discovery apparatus 604, it will be apparent from the following description that the discovery of one or more of the apparatus 604-608 may or might not be performed by the discovery apparatus 604. Thus, for example, the first and second responding apparatus 606, 608 may discover the discovery apparatus 604. As such, in some embodiments the discovery apparatus 604 may alternatively be referred to as a lead or leader apparatus (e.g., to indicate that the apparatus 604 may be responsible for the configuration of the apparatus 604-608 in some embodiments). In some embodiments, the discovery apparatus 604 may be referred to as the primary apparatus 604 and the first and second responding apparatus 606, 608 may be referred to as secondary apparatus 606, 608.

The network device 602 may be the network device 502 described above in respect of FIG. 5, for example. In general, the network device 602 may a base station or TRP, such as one of the TRPs 170 described above in respect of FIGS. 1-4. The network device 602 may be in a radio access network (e.g., one of the radio access networks 120 described above in respect of FIGS. 1-4). The network device 602 may be operable to connect the apparatus 604-608 to a core network of a communication network (e.g., the core network 130 of the system 100).

Each of the apparatus 604-608 may be any suitable apparatus. In some embodiments, each of the apparatus 604-608 may be an electronic device, such as any of the electronic devices 110 described above in respect of FIGS. 1-4. Each of the apparatus 604-608 may comprise respective components for transmitting and receiving signals (e.g., as described above in respect of the apparatus 504-508). In some embodiments, one or more of the apparatus 604-608 may be the first apparatus 504 or the second apparatus 506. One or more of the first apparatus 504, second apparatus 506 and third apparatus 508 may be sensing apparatus (e.g., may comprise one or more sensors).

There is a respective channel between each of the apparatus 604-608 and the network device 602: a first channel between the discovery apparatus 604 and the network device 602, a second channel between the first responding apparatus 606 and the network device 602 and a third channel between the second responding apparatus 606 and the network device 602.

The method 600 may begin with the discovery apparatus 604 transmitting a discovery message 610 (e.g., a discovery signal 610). The discovery apparatus 604 may broadcast the discovery message 610, for example. The discovery apparatus 604 may transmit the discovery message 610 using a plurality of beams (e.g., by performing beam sweeping). The discovery message 610 may comprise an identifier for the discovery apparatus 604, for example. The discovery message may be sent on a sidelink (SL) channel or a device-to-device (D2D) channel.

The discovery message 610 is received by the first and second responding apparatus 606, 608 (the responding apparatus 606-608 collectively). Each of the responding apparatus 606, 608 sends a respective acknowledgement message (e.g., a confirmation message) 612a, 612b to the discovery apparatus 604. The acknowledgement messages 612a, 612b may be sent in response to the discovery message 610.

In some embodiments, the acknowledgement messages 612a, 612b may be transmitted responsive to determining, at a respective responding apparatus 606, 608 that the respective channel between the responding apparatus 606, 608 and the network device 602 is expected to be correlated with the channel between the discovery apparatus 604 and the network device 602. Thus, for example, the first responding apparatus 606 may transmit the acknowledgement messages 612a responsive to determining that the channel between the first responding apparatus 606 and the network device 602 is expected to be correlated with the channel between the discovery apparatus 604 and the network device 602.

Each responding apparatus 606, 608 may determine that its channel (e.g., the second channel or the third channel) is expected to be correlated with the first channel (of the discovery apparatus 604) using any of the operations described above in respect of the determination, by the network device 502, that the first and second channels are expected to be correlated in the method 500. Thus, each responding apparatus 606, 608 may determine that the respective channels are expected to be correlated based on one or more of: a channel correlation estimate for the respective channels, a difference between measurements of the respective channels, the respective locations of the discovery apparatus 604 and the respective responding apparatus 606, 608, and a measurement of a channel between the discovery apparatus 604 and the respective responding apparatus 606, 608, or any other suitable factors. For ease of understanding, potential adaptations of operations from the method 500 for determining, by the responding apparatus 606, 608, that the channels are expected to be correlated are described below with reference to the first responding apparatus 606 and the determination that its respective channel (the second channel) is expected to be correlated with the first channel. However, it will be understood that the same operations may also be implemented by the second responding apparatus 608 to determine that the third channel (for the second responding apparatus 606) is expected to be correlated with the first channel (for the discovery apparatus 604).

In some embodiments, the first responding apparatus 606 may make the determination that second channel is expected to be correlated with the first channel based on information received from the discovery apparatus 604. The information may be received in the discovery message 610, for example. The received information may include, for example, a location of the discovery apparatus 604 and/or an estimate of the first channel (between the discovery apparatus 604 and the network device 602).

In one example, the first responding apparatus 606 may determine that the second and first channels are expected to be correlated by determining, based on a comparison of its own location and the received location of the discovery apparatus 604, that the discovery apparatus 604 and the first responding apparatus 606 have a same or similar location. The responding apparatus 606 may determine that the discovery apparatus 604 and the first responding apparatus 606 have a same or similar location using any of the methods described above in respect of the network device 502, for example.

In another example, the first responding apparatus 606 may determine that the second and first channels are expected to be correlated by performing one or more measurements of the second channel (e.g., by measuring one or more reference signals received from the network device 602) and comparing the estimate of the second channel with the estimate of the first channel received from the discovery apparatus 602 (e.g., determining a channel correlation estimate and/or a difference between the two channels).

In some embodiments, the first responding apparatus 606 determines that second channel is expected to be correlated with the first channel by performing a measurement (e.g., at least one measurement) on one or more signals received from the discovery apparatus 604 and determining an estimate of the channel between the first responding apparatus 606 and the discovery apparatus 604 based on the measurement. The measurement may be performed on the discovery message 610 (e.g., on one or more reference signals, such as CSI-RS in SL in the discovery message 610) or it may be simply performed on a SL reference signal, such as a SL CSI-RS sent by the discovery apparatus 604 that might not be part of the discovery message.

In some embodiments, the first responding apparatus 606 may perform sensing to determine the respective locations of the discovery apparatus 604 and the first responding apparatus 606. For example, the first responding apparatus 606 may determine a separation (e.g., distance or signal travel time) between the first responding apparatus 606 and the discovery apparatus 604 by transmitting one or more sensing signals (e.g., radio signals) and receiving a reflection of at least one of the one or more sensing signals reflected by the discovery apparatus 604.

Thus, in some embodiments, each responding apparatus 606, 608 may determine that the respective channel between the respective responding apparatus 606, 608 and the network device 602 is expected to be correlated with the channel between the discovery apparatus 604 and the network device 602. As noted above, the acknowledgement messages 612a, 612b may be transmitted responsive to this determination. As such, in some embodiments, the transmission of the acknowledgement messages 612a, 612b may indicate to the discovery apparatus 604 that the respective channels between the responding apparatus 606, 608 and the network device 602 are expected to be correlated with the channel between the discovery apparatus 604 and the network device 602. The discovery apparatus 604 may thus determine, based on receipt on the acknowledgement messages 612a, 612b, that the apparatus 604-608 are correlated apparatus (e.g., are intra-UEs).

In some embodiments, one of the first and second responding apparatus 606, 608 may determine that their respective channel is expected to be correlated with the respective channel of the of the first and second responding apparatus 606. For example, the first responding apparatus 606 may determine that the second channel and the third channel are expected to be correlated. The first responding apparatus 606 may make the determination that second channel is expected to be correlated with the third channel based on information received from the second responding apparatus 608. The received information may include, for example, one or more of: a location of the second responding apparatus 606, an estimate of the second channel (between the responding apparatus 606 and the network device 602), and a measurement (or estimate) of the channel between the first responding apparatus 606 and the second responding apparatus 608 and one or more sensing results obtained by the second responding apparatus 608. The second responding apparatus 608 may obtain the one or more sensing results by transmitting one or more sensing signals (e.g., radio signals) and receiving a reflection of at least one of the one or more sensing signals (e.g., reflected by the first responding apparatus 606). The second responding apparatus 608 may send the information directly to the first responding apparatus 606 (e.g., in a one-to-one transmission). Alternatively, the second responding apparatus 608 may broadcast the information (e.g., in a one-to-many transmission) and the broadcasted information may be received by the first responding apparatus 606.

In other embodiments, the determination that the channels are expected to be correlated may be made at the discovery apparatus 604. The discovery apparatus 604 may make the determination using any of the methods described above in respect of the determination being made at the responding apparatus 606, 608. The discovery apparatus 604 may, for example, make the determination based on one or more measurements performed by the discovery apparatus 604 (e.g., to determine channel estimates) and/or information received from the responding apparatus 606, 608 (e.g., locations and/or channel measurements received from the responding apparatus 606, 608). The responding apparatus 606, 608 may send this information in the acknowledgement message 612, 612b or in another message. In some examples, the responding apparatus 606, 608 may broadcast this information (e.g., may broadcast one or more measurements and/or sensing results) and the broadcasted information be received by the discovery apparatus 604.

The discovery apparatus 604 may indicate, to the responding apparatus 606-608, that the channels are expected correlated. The discovery apparatus 604 may thus indicate the responding apparatus 606-608 that they are correlated or intra-UEs, for example. The discovery apparatus 604 may indicate this information in the apparatus-specific configurations or the common configuration discussed below, for example.

The discovery apparatus 604 may indicate (e.g., transmit), to the responding apparatus 606-608, respective apparatus-specific configurations 614a, 614b. Each apparatus-specific configuration 614a, 614b is assigned to a particular responding apparatus (e.g., is not shared by the apparatus 606-608 or the responding apparatus 606-608). The apparatus-specific configurations 614a, 614b may be the same as the apparatus-specific configurations described above in respect of the method 500. The discovery apparatus 604 may indicate (e.g., transmit) the apparatus-specific configurations 614a, 614b using sidelink (SL) signaling (e.g., using PC5-RRC or using sidelink control information, SCI).

In some embodiments, the discovery apparatus 604 might not indicate the respective apparatus-specific configurations 614a, 614b to the responding apparatus 606-608. For example, the responding apparatus 606-608 may be preconfigured with the apparatus-specific configurations. In another example, the responding apparatus 606-608 may determine their respective apparatus-specific configurations. Some or all of the apparatus-specific configuration parameters may be randomly selected by the respective responding apparatus 506, 508 (e.g., by selecting a random codebook from a pool) and/or derived from a predefined relationship with configured (e.g., known) or measurement parameters (e.g., a codebook derived from an identifier for the responding apparatus, such as a UE ID).

The discovery apparatus 604 may further determine its own apparatus-specific configuration. For example, the discovery apparatus 604 may assign itself an apparatus-specific identifier.

The discovery apparatus 604 may optionally transmit a request 616, to the network device 602, for a common configuration for the apparatus 604-608. The discovery apparatus 604 may additionally include, in the request 616, information from the apparatus-specific configurations for the apparatus 606. For example, the request 616 may include the apparatus-specific identifiers for the apparatus 604-608. The request 616 may further include additional information about the apparatus 604-608. The additional information may include, for example, the quantity of the apparatus 604-608 (e.g., three in this example) and/or traffic information for the apparatus 604-608 (e.g., which may have been reported from the responding apparatus 606, 608 to the discovery apparatus 602). The request 616 may be transmitted as part of one or more of the following: an initial access process, an RRC connection establishment process, a scheduling request, any other uplink transmission process or a separate configuration request message.

The discovery apparatus 604 may receive an indication 618 of the common configuration for the apparatus 604-608 from the network device 602. The indication may be transmitted by the network device 602 in response to the request 616.

The common configuration is different to the apparatus-specific configuration. The common configuration may be the same as the common configuration described above in respect of the method 500. The common configuration may, for example, include one or more of: a common DMRS, a common identifier, and/or a grant-free configuration described above in respect of the method 500.

As discussed above in respect of the method 500, the common identifier for the apparatus 604-608 may indicate that the apparatus 604-608 belong to a single logic node identified by the common identifier. Thus, from the perspective of the network device 602, the apparatus 604-608 may logically form one entity. The logic node or entity may be represented, at the network device 602, by the discovery apparatus 604. As such, the network device 602 may send information that is intended for all apparatus in the logic node/entity (e.g., the common configuration) to the discovery apparatus 604. The discovery apparatus 604 may then communicate the information to the responding apparatus 606-608.

The discovery apparatus 604 indicates the common configuration 620a, 620b to the responding apparatus 606-608. The discovery apparatus 604 may also implement the common configuration itself (e.g., may transmit a common DMRS included in the common configuration). The discovery apparatus 604 may transmit an indication of the common configuration 620a, 620b directly to the responding apparatus 606-608 (e.g., in respective one-to-one communications). Alternatively, the discovery apparatus 604 may broadcast/multicast the indication (e.g. via a group common PC5-RCC signaling) of the common configuration 620a and the broadcasted indication may be received by the responding apparatus 606, 608. Thus, for example, the broadcasted indication may be received by all apparatus belonging to a same logic entity as the responding apparatus 606, 608. The discovery apparatus 604 may indicate (e.g., transmit) the common configuration 620a, 620b using sidelink (SL) signaling (e.g., using PC5-RRC, a group common PC5-RRC, or using sidelink control information, SCI).

Each of the apparatus 604-608 may further transmit a respective message 622a, 622b, 622c (collectively 622) to the network device 602 in accordance with the common configuration. Thus, in some embodiments, the apparatus 604-608 may transmit a same DMRS (as indicated by the common configuration) to the network device 602 in the messages 622. The messages 622 may be transmitted in the same manner as the transmission of the same DMRS 516a, 516b described above in respect of FIG. 5.

The messages 622 may further be transmitted in accordance with the apparatus-specific configurations for the respective apparatus 604-608. For example, one or more of the messages 622 may include the apparatus-specific identifier for the respective apparatus 604-608 (e.g., the apparatus transmitting the message 622).

In the above description of the method 600, the discovery apparatus 604 transmits the apparatus-specific configurations 614a, 614b before the common configuration 620a, 620b. In other embodiments, the common configuration may be transmitted first (e.g., the common configuration may be requested from the network device 602 before the apparatus-specific configuration is transmitted). In some embodiments, the common configuration and the apparatus-specific configuration for a particular responding apparatus 606-608 may be transmitted together (e.g., in the same message). In an example, the discovery apparatus 604 may request (e.g., in the request 616) the common configuration and the apparatus-specific configurations from the network device 602 and transmit the common configuration and the apparatus-specific configuration to a particular responding apparatus 606, 608 in a single message.

The method 600 may be performed during an initial access procedure (e.g., for providing one or more of the apparatus 604-608 with access to a network including the network device 602). In some examples, the signaling described above in the method 600 be performed using RRC signaling (e.g., during configuration of connected or inactive states via RRC signaling). In one example, the request 616 may comprise an RRC Connection Request message and the response 618 may comprise an RRC Connection Setup message. In some examples, the request 616 and/or the response 618 may comprise a Random Access Message. For example, the request 616 may comprise a Random Access Preamble (e.g., a message sometimes referred to as “msg1”) and the response 618 may comprise a Random Access Response (e.g., a message sometimes referred to as “msg2”).

### Multiple Access

Multiple apparatus (e.g., sensing apparatus, such as sensors) connected to a network device may have different packet arrival times. As a result, different apparatus may be active (e.g., transmitting to the network device) at different times, and the number of apparatus seeking to access the channel (e.g., based on a shared grant-free configuration) may vary.

According to aspects of the present disclosure, a first multiple access scheme may be used by two or more first apparatus for communications with a network device, in which the channels between the network device and the two or more first apparatus are expected to be correlated (e.g., in the same manner that the first and second channels of the first and second apparatus 504, 506 are expected to be correlated as described above). A second multiple access scheme, different to the first multiple access scheme, may be used by a second apparatus for communications with the network device. The channel between the second apparatus and the network device might not be expected to be correlated (or may be less correlated) with the channels between the network device and the two or more first apparatus. The second multiple access scheme is discussed in more detail below.

The skilled person will appreciate that there are various multiple access schemes which may be used for the first multiple access scheme.

### Multiple Access: Code Domain Multiple Access

In some embodiments, the first multiple access scheme may include a code domain multiple access scheme. The two or more first apparatus may thus use a same codebook (e.g., of the code domain multiple access scheme). The codebook may comprise a plurality of codewords (e.g., codes). The two or more first apparatus may select, from the codebook, a respective codeword to use for encoding transmissions to the network device

The codebook may comprise an orthogonal codebook. Thus, the codebook may comprise a plurality of orthogonal codewords. As the codewords are orthogonal, even if the two or more first apparatus transmit to the network device at the same time, and the network device receives a combined transmission (e.g., the transmissions by the two or more first get added in the air and are multiplexed together), the network device can decode the received transmission using the respective codewords, and separate the transmissions from the two or more first apparatus. Using orthogonal codewords may thus allow the network device to distinguish between transmissions from the two or more first apparatus. The correlation between the channels of the two or more first apparatus mean that the orthogonality of the codewords should be maintained. In contrast, if the channels of the two or more first apparatus were not correlated, the two or more first apparatus may experience different independent fading channels, which may prevent the orthogonality of the codewords from being maintained. As such, the use of an orthogonal codebook for apparatus having correlated channels allows the network device to support multiple apparatus (even up to large numbers of apparatus) efficiently.

In particular examples, the codewords in the codebook may be generated from a parity check matrix of a Bose-Chaudhuri-Hocquenghem (BCH) code. In particular examples, the two or more first apparatus may encode transmissions using concatenated BCH-Forward Error Correction (FEC) coding, in which a BCH parity check matrix-based code is used as an outer code and an FEC code is used as an inner code. The codeword for the outer BCH code may be generated from the columns of the parity check matrix of the binary BCH code.

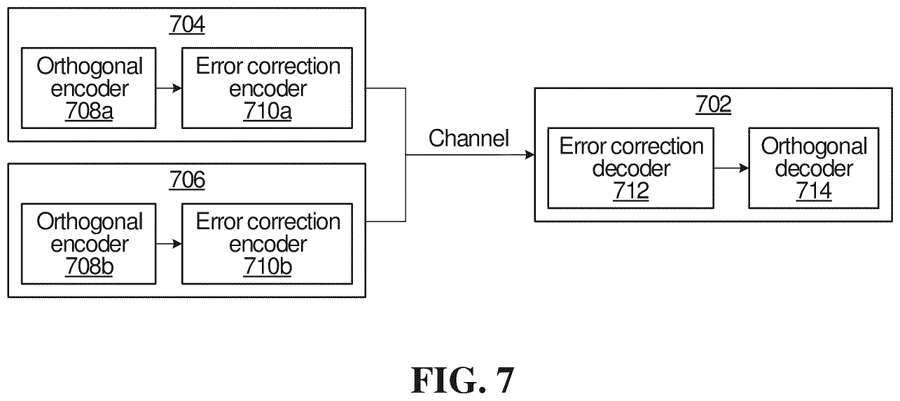

An example implementation of BCH-FEC coding may be described with reference to FIG. 7, which shows a network device 702, a first electronic device 704 and a second electronic device 706 according to embodiments of the disclosure. The first channel between the network device 704 and the first electronic device 704 is expected to be correlated with the second channel between the network device 702 and the second electronic device 706. Although this example is described with reference to the first and second electronic devices 704, 706, the skilled person will appreciate it may be generalized to the two or more first apparatus which are expected to have correlated channels.

The network device 702 may be the network device 502 or the network device 602. The first electronic device 704 and the second electronic device 706 may be the first apparatus 504 and the second apparatus 506, or any two of the discovery apparatus 604, the first responding apparatus 606 and the second responding apparatus 608.

Each of the first electronic device 704 and the second electronic device 706 includes a respective orthogonal encoder 708a, 708b and a respective error correction encoder 710a, 710b. The encoding process involves a concatenation of the respective orthogonal encoder 708a, 708b (e.g., the outer code) and the respective error correction encoder 710a, 710b (e.g., the inner code). The orthogonal encoder 708a in the first electronic device 704 encodes a first message for transmission by the first electronic device 704 using a first BCH codeword to obtain an encoded first message. The orthogonal encoder 708b in the second electronic device 706 encodes a second message for transmission by the second electronic device 706 using a second BCH codeword. The first and second BCH codewords may be different columns of a BCH parity-check matrix. The BCH parity-check matrix may be generated according to its error correcting capability. Examples of BCH code and generating its parity check matrix may be found in Shu Lin, D. J. Costello, Error Control Coding, 2nd edition, Pearson Prentice Hall, Upper Saddle River, 2004.

An example BCH parity-check matrix that may be used may be expressed as:

$$H = [ \begin{matrix}1 & α & {α}^{2} & {α}^{3} & … & {α}^{n - 1} \\ 1 & ( {α}^{3} ) & {( {α}^{3} )}^{2} & {( {α}^{3} )}^{3} & … & {( {α}^{3} )}^{n - 1} \\ 1 & ( {α}^{5} ) & {( {α}^{5} )}^{2} & {( {α}^{5} )}^{3} & … & {( {α}^{5} )}^{n - 1} \\ ⋮ & ⋮ & ⋮ & ⋮ & … & ⋮ \\ 1 & ( {α}^{2 t - 1} ) & {( {α}^{2 t - 1} )}^{2} & {( {α}^{2 t - 1} )}^{3} & … & {( {α}^{2 t - 1} )}^{n - 1}\end{matrix} ] .$$

in which α is a primitive element in the Galois Field GF (2^{k}), in which k is a positive integer that satisfies n=2^{k}−1, n is the block length of the BCH code, and t is the maximum number of errors that the BCH code can correct.

As a result of the properties of BCH code (e.g., as described in Error Control Coding, referenced above), no 2t or fewer columns of H sum to zero, which may guarantee the BCH code distance. The sum of at most t distinct columns of H is distinct. As a result, this means that the columns of H can be used as codewords and the modulo-2 sum of any set of at most t distinct codewords will be distinct. Thus the decoder can distinguish which t distinct codewords are transmitted based its modulo-2 sum.

The error correction encoder 710a in the first electronic device 704 encodes the encoded first message using an FEC code. Similarly, the error correction encoder 710b in the second electronic device 706 encodes the encoded second message using the FEC code. The same FEC code is used by both the error correction encoders 710a, 710b. Any suitable FEC code may be used. In particular examples, a linear code that performs well in binary memoryless channel, such as, for example, an LDPC code, a Turbo code, or a Polar code may be used. The FEC code (e.g., the inner code) may be a systematic binary linear code.

The twice-encoded first message and the twice-encoded second message are modulated and transmitted to the network device 702 by the first electronic device 704 and the second electronic device 706. Since the first channel between the network device 704 and the first electronic device 704 is expected to be correlated with the second channel between the network device 702 and the second electronic device 706, the twice-encoded first and second messages are effectively transmitted over the same channel. The network device 702 receives a combined signal which includes the twice-encoded first and second messages.

An error correction decoder 712 in the network device decodes the combined signal to output a single codeword. The single codeword may be used to correct any errors in the received combined signal.

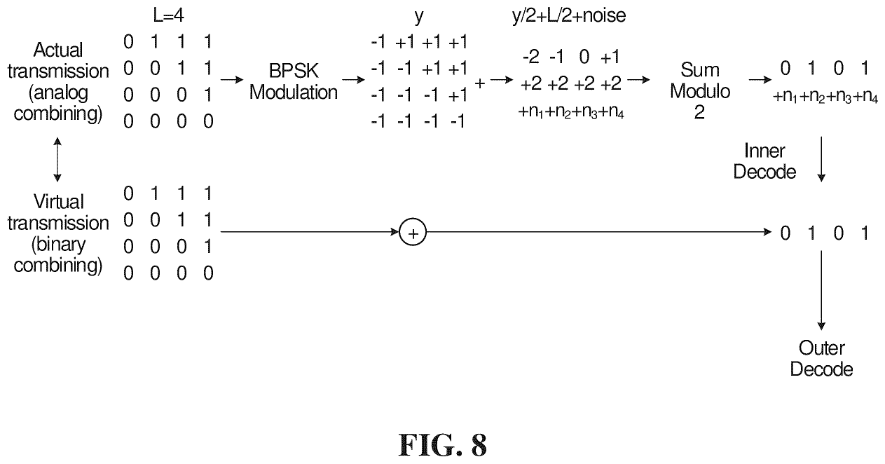

An example of encoding and decoding the inner code for BCH-FEC coding (e.g., of encoding and decoding the FEC code) is described with respect to FIG. 8. This example is for an embodiment in which L=4 electronic devices which are expected to have correlated channels transmit to a network device. In the illustrated example, signals for transmission by the four apparatus are encoded using BCH-FEC coding (e.g., in accordance with the operation of the orthogonal encoders 708a, 708b and the error correction encoders 710a, 710b described above) to produce respective coded bits:
c₁=[0 1 1 1],
c₂=[0 0 1 1],
c₃=[0 0 0 1],
c₄=[0 0 0 0].

At each electronic device, the respective coded bits c; are modulated using Binary Phase-shift keying (BPSK) modulation. Thus, (+1, −1) is the normalized amplitude of the two constellations after BPSK modulation. As such, the transmitted signal after modulation at different time slots for each electronic device may be expressed as

$${x}_{i} = 2 {c}_{i} - 1$$

such that, for example:

$${x}_{1} = [ \begin{matrix}- 1 & + 1 & + 1 & + 1\end{matrix} ] ,$$

$${x}_{2} = [ \begin{matrix}- 1 & - 1 & + 1 & + 1\end{matrix} ] ,$$

$${x}_{3} = [ \begin{matrix}- 1 & - 1 & - 1 & + 1\end{matrix} ] ,$$

$${x}_{4} = [ \begin{matrix}- 1 & - 1 & - 1 & - 1\end{matrix} ] .$$

The electronic devices transmit the modulated coded bits to the network device. The network device receives a combined signal y which may be expressed as

$$y = {\sum }_{i = 1}^{L} {x}_{i} + n = 2 {\sum }_{i = 1}^{L} {c}_{i} - L + n$$

This is the sum of the signal transmitted by each apparatus, xi, plus additive white Gaussian noise (AWGN) n to simulate an AWGN channel. For simplicity, it is assumed that the transmit power and gain is normalized to 1, although the skilled person will appreciate that this expression may be generalized to account for the electronic devices having different transmit powers and/or gains.

The network device can decode the combined received signal y by adding y/2+L/2 to the received signal y, denoising and performing a modulo 2 sum (“Modulation 2” in FIG. 8) on the denoised signal. This is because

$$\frac{y}{2} + \frac{L}{2} = \frac{1}{2} * ( 2 {\sum }_{i = 1}^{L} {c}_{i} - L + n ) + \frac{L}{2} = {\sum }_{i = 1}^{L} {c}_{i} + n$$

This results in recovery of modulo 2 sum of the coded bits Σᵢ₌₁^{L} cᵢ in the binary domain. For the example, if we substitute xᵢ (i=1,2,3,4) values in the combined signal y, we obtain

$$y = {\sum }_{i = 1}^{L} {x}_{i} + n = [ - 4 , - 2 , 0 , 2 ] + n$$

and as L=4 in the example, we have

$$\frac{y}{2} + \frac{L}{2} = [ 0 , 1 , 0 , 1 ] + n$$

which recovers the modulo 2 sum of the coded bits in binary domain

Σᵢ₌₁^{L} cᵢ=0101

This result can be sent to the decoder for the channel codes in the binary domain to decode. Although the example described in respect of FIG. 8 is for four electronic devices, rather than the two electronic devices 704, 708 discussed above in respect of FIG. 7, the skilled person will appreciate that it may in general be adapted for the two or more first apparatus which are expected to have correlated channels. For example, the operations discussed above in respect of the L=4 apparatus may be performed by the first electronic device 704 and the second electronic device 706. Operations discussed in respect of a network device may be performed by the network device 702.

An orthogonal decoder 714 in the network device decodes the (corrected) combined signal using the first BCH codeword and the second BCH codeword to obtain the first and second message. The orthogonal decoder 714 may de-multiplex (e.g., separate out) the first and second messages in the binary domain.

BCH parity check matrix-based coding is an example of a nonlinear orthogonal code. BCH, and in particular, BCH-FEC, may be particularly advantageous since it provides a low cost and low complexity method for multiplexing and demultiplexing payloads from a large number of apparatus (e.g., from a large number of sensors). In addition, BCH-FEC may be difficult to use for apparatus that do not have correlated channels since it may be difficult to turn an analog combining of modulated codewords that is scaled with different fading coefficients to an equivalent binary combining in FEC domain. Further details regarding BCH-FEC encoding and decoding may be found in O. Ordentlich and Y. Polyanskiy, “Low complexity schemes for the random access Gaussian channel,” 2017 IEEE International Symposium on Information Theory (ISIT), 2017, pp. 2528-2532, doi: 10.1109/ISIT.2017.8006985. Therefore, according to aspects of the disclosure, BCH parity check matrix-based coding, such as the schemes described in the aforementioned reference, may be used for the two or more first apparatus which are expected to have correlated channels.

In other examples, other nonlinear orthogonal codes may be used. Thus, the two or more first apparatus may, in general, use a same nonlinear orthogonal codebook. In this context, the codebook being nonlinear may mean that the orthogonal codewords cannot be combined to produce another codeword. In particular examples, the codebooks may be orthogonal in the binary domain such that it is possible to distinguish a unique set of t distance codewords based on their modulo 2 sum.

In yet other examples, the codebook may be a linear orthogonal codebook. In particular examples, the codebook may be a linear orthogonal codebook and the first multiple access scheme may be an unsourced multiple access scheme. In these examples, the linear orthogonal codebook may be a random linear orthogonal codebook. In general, any linear orthogonal codebook that may give the best performance may be used.

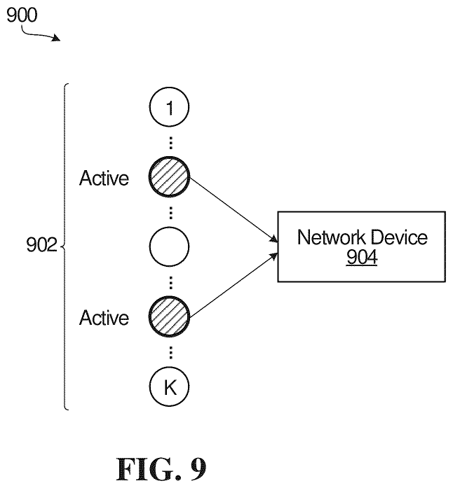

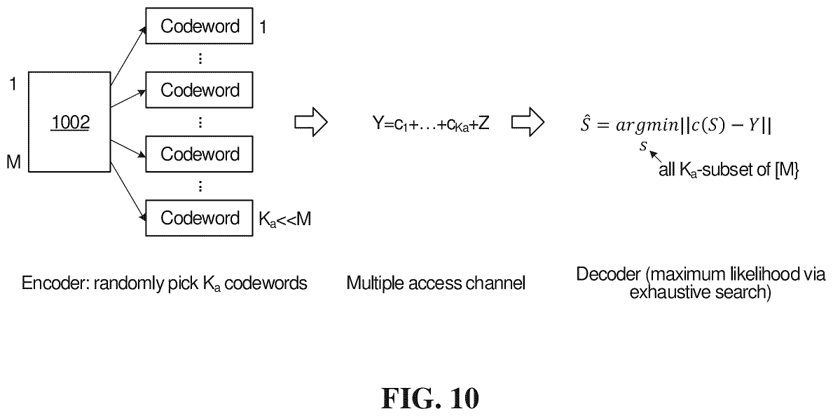

An example of an unsourced multiple access scheme using a linear orthogonal codebook that may be implemented for the two or more first apparatus is described with reference to FIGS. 9 and 10.

FIG. 9 shows an example of a system 900 according to embodiments of the disclosure. The system 900 includes the two or more first apparatus 902 of which a subset Ka are active. In this context, an apparatus is active when transmits or it is to transmit to the network device 904. The two or more first apparatus 902 form a pool of apparatus which could be active, e.g., could transmit to the network device 904. However, only some of the apparatus in the two or more first apparatus 902 are active at any one time. The number of active apparatus is generally much less than the total number of apparatus that could potentially transmit, such that Ka<<K, in which K is the number (e.g., quantity) of the two or more first apparatus 902.

FIG. 10 shows a flowchart illustrating a method for implementing unsourced multiple access for the two or more first apparatus 902 according to embodiments of the disclosure. In the method, the two or more first apparatus 902 share a same linear orthogonal codebook 1002. The codebook 1002 includes M codewords, in which M>>Ka. Each of the active apparatus selects a respective codeword from the codebook 1002. The codeword for a respective active apparatus may be selected from the codebook 1002 at random. Each active apparatus encodes its respective signal (e.g., message or transmission) according to its selected codeword and transmits the encoded signal to the network device 904.

The network device 904 receives a combined signal which is a sum of all of the encoded signals, ci for i=1, . . . . Ka, from the respective active apparatus plus any noise due to the channel, Z. Thus, the network device 904 may receive the combined signal Y according to:

$$Y = {c}_{1} + … + {c}_{{K}_{a}} + Z .$$

The network device 902 may decode the combined signal by determining, based on the combined signal, which of the M codewords from the codebook are most likely to be present. The network device 902 may, for example, use maximum likelihood decoding (e.g., using an exhaustive search). For example, the network device 902 may decode the combined signal to obtain the transmitted signals by seeking to solve:

$$\hat{S} = arg min \vert c ( S ) - Y \vert ,$$

in which Sis the subset of Kₐ codewords from the codebook containing M codewords. Ŝ is the decoder output of which subset of Kₐ codewords from the codebook are active from all possible subset of Kₐ codewords from the codebook. Unsourced here indicates that the decoder does not identify which apparatus is transmitting before decoding, but rather, it determines the messages based on which codewords are active. After decoding a message, the receiver may determine which apparatus transmitted the message based on the message itself or using other information.

The example described with reference to FIGS. 9 and 10 is just one example implementation of an unsourced multiple access scheme for the two or more first apparatus which are expected to have correlated channels. Further information regarding unsourced multiple access schemes may be found in Y. Polyanskiy, “A perspective on massive random-access,” 2017 IEEE International Symposium on Information Theory (ISIT), 2017, pp. 2523-2527, doi: 10.1109/ISIT.2017.8006984. According to aspects of the disclosure, unsourced multiple access schemes, such as those disclosed in the aforementioned reference, may be used for the two or more first apparatus which are expected to have correlated channels. In general, an unsourced multiple access scheme may be particularly advantageous when the two or more first apparatus are to transmit small messages (e.g., the number of bits, k, to be transmitted by each apparatus to the network device 502 is small).

Thus, in some embodiments, the first multiple access scheme used by the two or more first apparatus may include a code domain multiple access scheme.

### Multiple Access: Power Domain Multiplexing

In some embodiments, the first multiple access scheme may comprise power domain multiplexing. In power domain multiplexing, different transmitters (e.g., the two or more first apparatus) may be assigned different transmission powers (e.g., different power levels) such that a receiver (e.g., the network device) can distinguish between their transmissions. This may be referred to as superposed modulation or virtual superposition coding. Note the virtual superposition coding here is different from traditional or conventional superposition coding. Conventionally, superposition coding is used in a multicast scenario, in which the transmitter is transmitting to multiple receivers and superposes the messages for different receivers before transmission.

In contrast, according to embodiments of the disclosure, each of the two or more first apparatus transmits its own message or signal with a respective transmission power (e.g., a respective power level). Thus, power domain multiplexing may be applied to many-to-one transmissions.

The signals transmitted by the two or more first apparatus are superposed in the air and the superposed (or combined) signal is received at the network device. Due to the different transmission powers and the correlation of the channels for the two or more first apparatus, the resultant constellation at the network device looks like the constellation that would arise from traditional superposition coding use for multicast transmission. As such, it is referred to as virtual superposition coding or superposed modulation. This may be an example of a non-orthogonal multiple access scheme that may be used as the first multiple access scheme.

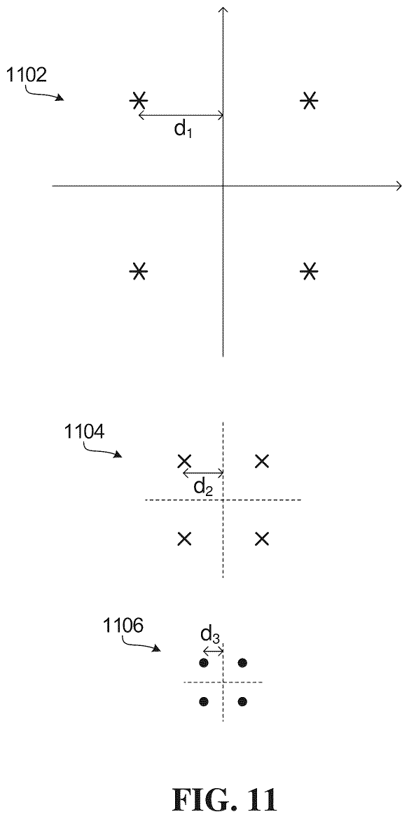

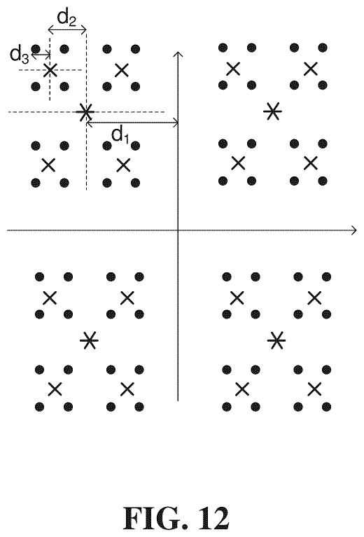

This may be further illustrated by reference to FIGS. 11 and 12. FIG. 11 shows respective constellation diagrams 1102, 1104, 1106 for signals transmitted by a first electronic device, a second electronic device and a third electronic device to a network device according to a power domain multiplexing scheme in embodiments of the disclosure. The respective channels between the three electronic devices and the network device are expected to be correlated. The first electronic device has the highest transmission power, the third electronic device has the smallest (lowest) transmission power, and the second electronic device has a transmission power that is between that of the first and third electronic device. If the distance between the respective constellation points of the first, second and third electronic devices to the x or y axis are denoted as d1, d2 and d3 with d1>d2>d3, respectively, then their power level is proportional to d12, d22 and d32.

FIG. 12 shows a constellation diagram at the network device resulting from the transmissions made by the three electronic devices according to embodiments of the disclosure. This example assumes the channels for the three electronic devices are similar and the three electronic devices use Quadrature Phase Shift Keying (QPSK) modulation. As noted above, d1, d2 and d3 (with d1>d2>d3) are the distances between the respective constellation points of first, second and third electronic devices to its respective x or y axis, respectively, in which their power level is proportional to d12, d22 and d32. The star shows the constellation for the first electronic device as shown in FIG. 11, which has the highest power level. The cross shows the potential constellations of the combined signals from the first electronic device and second electronic device, in which the second electronic device has smaller power level than the first electronic device but shares similar channel to the first electronic device. The dots show the overall potential constellation of the received signal that combines the signal transmitted by the first, second and third electronic devices, in which the third electronic device has the smallest power level and all three electronic devices have similar channels (e.g., similar channel conditions).

As shown in FIG. 12, the resultant constellation at the network device is similar to the constellation that would be achieved using a hierarchical modulation scheme. Thus, the network device can separate out the transmissions from the three electronic devices (e.g., using successive interference cancellation, SIC). For example, the network device can demodulate all signals received from the three electronic devices using the same or similar approaches that are used to demodulate a hierarchical modulation. The network device may first demodulate the signal received from the first electronic device by treating the signals from the other electronic devices signal as noise (e.g., as first apparatus is transmitted with the highest power). The network device may then remove then the signal transmitted by the first electronic device from the combined signal (e.g., using successive interference cancellation scheme) and use the remaining signal to demodulate the signal transmitted by the second electronic device. This procedure may proceed until the signals transmitted by all of the electronic devices are decoded.

Although FIGS. 11 and 12 show constellations for signal transmitted by three electronic devices which are expected to have correlated channels, the skilled person will appreciate that the principles may be applied to the two or more first apparatus since, as described above, the two or more first apparatus are expected to have correlated channels.

Therefore, in some embodiments, each of the two or more first apparatus may be assigned a respective transmission power as part of a power domain multiplexing scheme. Each of the two or more first apparatus may further be assigned a respective phase adjustment as part of the power domain multiplexing scheme. The respective transmission powers and/or phase adjustments may be unique to each of the two or more first apparatus (e.g., each of the two or more first apparatus may be assigned a different transmission power and/or phase adjustment).

The respective transmission powers may be determined based on one or more of: a priority (e.g., a priority of the respective apparatus), an importance of the signal or message to be transmitted by a respective apparatus (e.g., the importance of a particular type of data to be transmitted) and a quality of service (QOS) criterion (e.g., a reliability requirement). For example, a first message to be transmitted by one apparatus in the two or more first apparatus may have a higher importance than a second message to be transmitted by another apparatus in the two or more first apparatus. The first message may, for example, require a higher reliability. The apparatus that is to transmit the first message may be assigned a higher transmission power (e.g., a higher power level) than the apparatus that is to transmit the second message.

In some embodiments, the respective transmission powers may be respective power scaling factors (e.g., may comprise an amount by which the transmission power of the apparatus is to be scaled or adjusted, rather than an absolute value for the transmission power). In the example described above in respect of FIGS. 11 and 12, the first electronic device may be assigned a power scaling factor of 5, the second electronic device may be assigned a power scaling factor of 3 and the third electronic device may be assigned a power scaling factor of 1. The power scaling factor for a particular apparatus may be derivable from an index assigned to the apparatus. In the example of the three electronic devices described with respect to FIGS. 11 and 12, the first, second and third electronic devices may be assigned indices 1, 2 and 3 respectively. The respective power scaling factors 5, 3 and 1 may be derivable from these indices (e.g., based on a look-up table or a predefined relation).

The respective phase adjustment may be determined based on measurements of the respective channels between the two or more first apparatus and the network device. The respective phase adjustments may be configured to compensate for a phase difference between the channels between the two or more first apparatus and the network device. This can improve error rate performance. This may be illustrated by considering the constellation diagram shown in FIG. 12. If the resultant phase for the first, second and third electronic devices are different, the constellations in FIG. 12 may be rotated with respect to each other, and the overall superposed constellation may have lower error rate performance. Instead, one of the electronic devices (e.g., the first electronic device) may be taken to be a reference for phase adjustment and the phases of the other electronic devices may be adjusted such that the transmissions from all three electronic devices are phase synchronized. Thus, if measurement shows the second electronic device and the third electronic device have respective channel phases that are A and B degrees rotated clockwise with respect to the first electronic device, then the phases for the second and third electronic devices may be adjusted A and B degrees counter-clockwise before transmission such that the transmission signals from all three electronic devices are phase synchronized.

Each of the two or more first apparatus may transmit to the network device according to their respective transmission power and/or phase adjustment. The two or more first apparatus may use their respective transmission power and phase adjustment in addition to any traditional power control schemes and/or configurations for transmissions to the network device (e.g., for uplink transmissions). The network device receives the transmissions from the two or more first apparatus transmitted according to the respective transmission powers. The network device may use the demodulation method described earlier to distinguish different apparatus using superposed modulation, e.g. using methods that may otherwise be used to demodulate hierarchical modulation or using a SIC decoding method.

Power domain multiplexing may be particularly advantageous since it can increase spectrum efficiency. In addition, the transmission power assigned to each apparatus may be configured to provide a particular level of error protection for the respective apparatus. Thus, for example, the transmission power may be determined according to a quality of service criterion (e.g., a reliability requirement). For example, the quality of service criteria for the two or more first apparatus may indicate that transmissions made by a particular apparatus of the two or more first apparatus is to be more reliable than transmissions made by another of the two or more first apparatus. Based on these quality of service criteria, the network device 502 may assign a first transmission power to the particular apparatus and a second transmission power to the other apparatus. For example, the network device 502 may assign a higher transmission power to the particular apparatus that requires a higher reliability. In general, implementing a higher transmission power (e.g., with an equal code rate) increases decoding reliability since the signal with the highest transmission power is decoded first, whereas signals with lower transmission power are only decoded after the signal with the highest transmission power is demodulated correctly.

In some examples, one or more of the two or more first apparatus may be assigned a particular FEC code rate based on target block error rate (BLER) for the respective apparatus. The FEC code rate can work together with power domain multiplexing (e.g., with superposed modulation) to achieve a desired target BLER. For example, if the two or more first apparatus have a target BLER of 0.1, and a particular apparatus in the two or more apparatus uses a higher transmission power (higher power level), this will yield a lower BLER for the same code rate. As such, the particular apparatus may be assigned a higher code rate than other apparatus in the two or more first apparatus (e.g., than other apparatus with lower transmission powers) such that all of the two or more first apparatus achieve a similar target BLER of 0.1.

### Multiple Access: Spreading Codes

In some embodiments, the first multiple access scheme may relate to a spreading code to be used by the two or more first apparatus. The skilled person will be familiar with spreading codes, so they will not be discussed here in detail. Briefly, a spreading code may be a code sequence that a transmitter applies to a signal to be transmitted (e.g., multiplies the signal by or uses on the transmitted signal) such that, when the signal is transmitted, it is spread over multiple different time-frequency resources. There are various spreading code-based multiple access schemes including orthogonal spreading code-based multiple access schemes and non-orthogonal spreading code-based multiple access schemes. An example of an orthogonal spreading code-based multiple access scheme is Third Generation (3G) code division multiple access (CDMA). Examples of non-orthogonal spreading code-based multiple access schemes include multiple user shared access (MUSA), non-orthogonal coded access (NOCA), non-orthogonal coded multiple access (NCMA), low code rate spreading (LCRS), and group orthogonal coded access (GOCA). Thus, in some embodiments, the two or more first apparatus may use a same spreading code-based multiple access scheme, such as any of the examples described above. For example, the two or more first apparatus may be assigned a pool of spreading codes (e.g., a plurality of spreading codes) and each of the two or more first apparatus may be assigned or select a respective spreading code from the pool to use for transmissions to the network device.

### Multiple Access: Hopping Sequences

In some embodiments, the first multiple access scheme may relate to a hopping sequence to be used by the two or more first apparatus. The skilled person will be familiar with hopping sequences, so they will not be discussed here in detail. Briefly, in a multiple access scheme based on a hopping sequence, a transmitter (e.g., one of the two or more first apparatus) transmits signals on different frequency resources over time based on an assigned hopping sequence. In embodiments of the disclosure, the two or more first apparatus may use the same hopping sequence-based multiple access scheme. For example, the two or more first apparatus may be assigned a pool of hopping sequences (e.g., a plurality of hopping sequences) and be assigned or select a respective hopping sequence from the pool to use for transmissions to the network device.

### Multiple Access: Signatures

In some embodiments, the first multiple access scheme may relate to a signature to be used by the two or more first apparatus. In general, a signature may be any sequence that a particular apparatus uses for transmission as part of a multiple access scheme. Thus, a signature for a particular apparatus may include one or more of: a spreading code (e.g., a spreading sequence), a code sequence, a hopping sequence, an interleaving sequence, a scrambling sequence or any other sequence to be used by the particular apparatus for multiple access transmission. As such, the spreading code-based multiple access and the hoping sequence-based multiple access described above may be examples of multiple access using signatures. Scrambling sequence-based multiple access may include resource spread multiple access (RSMA), low code rate and signature based shared access (LSSA). Interleaving sequence-based multiple access may include interleave-grid multiple access (IGMA), repetition division multiple access (RDMA), and interleave division multiple access (IDMA). Code sequence-based multiple access may include pattern defined multiple access (PDMA), low density signature (LDS), sparse coded multiple access (SCMA), etc.

Different signatures (e.g., any of the sequences described above) may be used for multiplexing signals (e.g., for transmissions by different apparatus). A particular signature may also be used to identify a particular apparatus.

In some embodiments, the two or more first apparatus may be assigned a pool of signatures (e.g., a plurality of signatures) and each respective first apparatus may select a signature from the pool to use for transmissions to the network device. The pool of signatures may be a same type of signatures (e.g., a spreading code, a code sequence, a hopping sequence, an interleaving sequence, a scrambling sequence). Thus, for example, the two or more first apparatus may be assigned a pool of interleaving sequences and be assigned or select a respective interleaving sequence from the pool to be used for transmissions to the network device.

Code domain multiple access, power domain multiplexing (also referred to as power division multiple access), spreading codes, signatures and hopping sequences are examples of multiple access schemes that may be used for the first multiple access scheme. In general, any multiple access scheme may be used, provided the two or more first apparatus use the same multiple access scheme for transmissions to the network device.

### Signalling for the First Multiple Access Scheme

In some embodiments of the disclosure, the network device may indicate, to the two or more first apparatus, a respective first parameter of the first multiple access scheme.

In some embodiments, the respective first parameters indicated to the two or more first apparatus may be the same. The network device may, for example, indicate a pool of parameters to the two or more first apparatus and each of the two or more first apparatus may select a respective parameter (e.g., at random) from the pool to be used for transmissions to the network device. For example, the network device may indicate a codebook (e.g., one of the codebooks discussed above) to the two or more first apparatus. The two or more first apparatus may select a respective code from the received codebook to use for transmissions to the network device. In other examples, the network device may indicate a plurality of spreading codes to the two or more first apparatus and the two or more first apparatus may select a respective spreading code from the plurality of spreading codes to use for transmissions to the network device. In another example, the network device may indicate a plurality of hopping sequences to the two or more first apparatus and the two or more first apparatus may select a respective hopping sequence from the plurality of hopping sequences to use for transmissions to the network device. In another example, the network device may indicate a plurality of signatures to the two or more first apparatus and the two or more first apparatus may select a respective signature from the plurality of hopping sequences to use for transmissions to the network device.

In other embodiments, the respective first parameters may be different. For example, the network device may indicate respective transmission powers (e.g., determined as discussed above) to each of the two or more first apparatus.

The network device may indicate the respective first parameters of the first multiple access scheme to the two or more first apparatus responsive to determining that the channels between the network device and the two or more first apparatus are expected to be correlated. For example, the network device 502 discussed above in respect of FIG. 5 may indicate, to the first and second apparatus 504, 506, respective parameters of a first multiple access scheme responsive to determining that the first and second channels are expected to be correlated. The network device 502 may use any suitable signaling to indicate the respective first parameters. The network device 502 may indicate the respective parameters in the common configuration (e.g., if the respective parameters are the same) or in the apparatus-specific configuration (e.g., if the respective parameters are different) described above, for example.

Alternatively, the network device may indicate the respective first parameters to the two or more first apparatus even if it is not aware that they are expected to have correlated channels. In some examples, the network device may receive a request to configure a multiple access scheme to be used by the two or more first apparatus. For example, the discovery apparatus 604 described above in respect of FIG. 6 may request that the network device 602 configures a same multiple access scheme to be used by the discovery apparatus 604, the first responding apparatus 606 and the second responding apparatus 608. The network device 502 may send the respective first parameters of the first multiple access scheme to the discovery apparatus 604, the first responding apparatus 606 and the second responding apparatus 608 responsive to receiving the request.

The network device 502 may determine the respective first parameters of the first multiple access scheme using any of the methods described above (e.g., may determine respective transmission powers for the first and second apparatus 504, 506 using the method described above).

In other embodiments, an apparatus other than the network device may indicate, to at least one of the two or more first apparatus, a respective first parameter of the first multiple access scheme. In some embodiments, one of the two or more first apparatus may transmit the indications. For example, the discovery apparatus 604 may indicate, to the first responding apparatus 606 and the second responding apparatus 608, a respective first parameter of the first multiple access scheme. The discovery apparatus 604 may use any suitable signaling to indicate the respective first parameters to the first and second responding apparatus 606, 608. For example, the discovery apparatus 604 may indicate the respective first parameters in the common configuration (e.g., if the respective first parameters are the same) or in the apparatus-specific configuration (e.g., if the respective first parameters are different) described above, for example.

The discovery apparatus 604 may further implement the first multiple access scheme according to its own respective first parameter. For example, the discovery apparatus 604 select a code from a codebook indicated to the first and second responding apparatus 606, 608 and use the code when performing transmissions to the network device 602.

The discovery apparatus 604 may determine the respective first parameters (e.g., according to any of the methods described above) or the discovery apparatus 604 may receive the respective first parameters (e.g., from the network device 602, such as on request from the network device 602).

Thus, some or all of the two or more first apparatus may receive an indication of a respective first parameter of the first access scheme. The indication may comprise the respective parameter itself or a factor (e.g., a quantity) from which the first parameter can be determined.

In one example, some or all of the two or more first apparatus may receive a respective apparatus index (e.g., an apparatus or UE index) and determine, based on the respective apparatus index, determine a respective transmission power. For example, an apparatus may be assigned (e.g. for the apparatus specific configuration), by e.g., the network device or a discovery apparatus, a unique apparatus index among the two or more first apparatus that have correlated channels (e.g., that share the same logic entity). The respective transmission powers of the two or more first apparatus may be based on their respective apparatus indices (e.g., among the logic entity that has correlated channels). For example, apparatus index 1 may be assigned or simply derived by itself as power scaling factor 5, apparatus index 2 may be assigned/determined to have a power scaling factor 3, and apparatus index 3 may be assigned/demined to have a power scaling factor 1. As another example, apparatus index 1 may have power scaling factor 1, apparatus index j may have power scaling factor 1/j.

In some embodiments, some or all of the two or more first apparatus may determine their own respective parameters of the first multiple access scheme. For example, each of the two or more first apparatus may determine their own transmission power and/or phase adjustment. The two or more first apparatus may make the determination responsive to receiving an indication of a type of multiple access scheme to be used (e.g., from the network device). For example, the two or more first apparatus may receive an indication that power domain multiplexing is to be used. In other examples, each of the two or more first apparatus may determine their own respective parameters responsive to determining that their respective channel with the network device is expected to be correlated with the respective channel between the network device and another of the two or more first apparatus. An example implementation of this is described above in respect of FIG. 6, in which the responding apparatus 606, 608 may determine that their channels are expected to be correlated with the channel between the discovery apparatus 604 and the network device 602. Thus, for example, each of the apparatus 604-608 may determine a transmission power (e.g., a power scaling) and/or phase adjustment in the discovery phase described above in the method 600.

In some examples, the respective parameter of the first multiple access scheme being used by a respective apparatus may be used to identify the apparatus. For example, a receiver (e.g., the network device) may detect the codeword used for a transmission and identify that the transmission was sent by a particular apparatus based on the codeword. This may be particularly appropriate when the receiver (e.g., the network device) configured the respective apparatus with the respective parameter.

### Second Multiple Access Scheme for the Second Apparatus

A second multiple access scheme, different to the first multiple access scheme, may be used by a second apparatus for communications with the network device. The network device may further indicate, to the second apparatus, a respective second parameter of the second multiple access scheme. For example, the network device 502 may indicate (e.g., transmit) a respective second parameter of the second multiple access scheme to the third apparatus 506.

The first and second multiple access scheme may be a same type of multiple access scheme (e.g., may both be code domain multiple access schemes) or they may be different types of multiple access schemes (e.g., the first multiple access scheme may involve power division multiplexing and the second multiple access scheme may use spatial domain multiplexing).

The second multiple access scheme may be any suitable type of multiple access scheme. The second multiple access scheme may involve one or more of: spatial domain multiplexing (e.g., using different beams and/or multiple-user multiple-input multiple-output), code domain multiple access (CDMA, such as orthogonal CDMA), time division multiple access (TDMA) and frequency division multiple access (FDMA, such as orthogonal CDMA).

In particular examples, the first multiple access scheme may be a non-orthogonal multiple access scheme and the second multiple access scheme may be an orthogonal multiple access scheme.

In particular examples, the second multiple access scheme might not be in the code domain. For example, the second multiple access scheme may involve spatial division multiplexing (e.g., using different beams), time division multiplexing and/or frequency division multiplexing (e.g., orthogonal frequency division multiplexing). In other examples, the second multiple access scheme may involve a code domain multiple access scheme. For example, the second apparatus may use a traditional channel coding scheme, such as a polar code, to encode a message and then apply an orthogonal spreading code (e.g., from a traditional codebook) to the encoded message for transmission to the network device.

Although the foregoing description of the second multiple access scheme refers only to one second apparatus, the skilled person will appreciate that, in general, there may be one or more second apparatus. Thus, one or more second apparatus, which are not expected to have correlated channels, may use the second multiple access scheme, which is different to the first multiple access scheme used by two or more first apparatus that have correlated channels.

### Groups of Correlated Apparatus

According to aspects of the disclosure described above, two or more apparatus (e.g., the first and second apparatus 504, 506, the apparatus 604-608 or the two or more first apparatus described above) may use a same DMRS, a common configuration and/or a first multiple access scheme for communications with a network device, in which the channels between the network device and the two or more first apparatus are expected to be correlated.

In further aspects of the disclosure, a plurality of apparatus that are connected to a network device may be grouped into two or more groups of apparatus that are expected to have correlated channels. In other words, the groups may be determined such that the channels between the network device and the apparatus in a respective group may be expected to be correlated. Each group may be referred to as a group of intra-UEs, for example. As described above in respect of FIGS. 5 and 6, a group of intra-UEs (or apparatus having correlated channels) may be treated as a single logic node or entity (e.g., a shared logic node).

Each group of apparatus may be assigned a common configuration. The common configuration may include, for example, one or more of: a common identifier (as defined above in respect of FIG. 5), a common DMRS (as described above in respect of FIGS. 5 and 6), a multiple access scheme (e.g., the first multiple access scheme described above), or any of the other parameters described above in respect of the common configuration.

The common configuration for a group may be sent to one of the apparatus for transmission to the other apparatus in the group (e.g., the discovery apparatus 604 receiving the common configuration and transmitting it to the first and responding apparatus 606, 608 as described above). Alternatively, the network device may transmit (e.g., broadcast) the common configuration for a group to all of the apparatus in the group.

In some embodiments, the method 500 may be performed in respect of each group of apparatus in the plurality of apparatus. In some embodiments, the method 600 may be performed in respect of each group of apparatus in the plurality of apparatus.

### Additional Methods

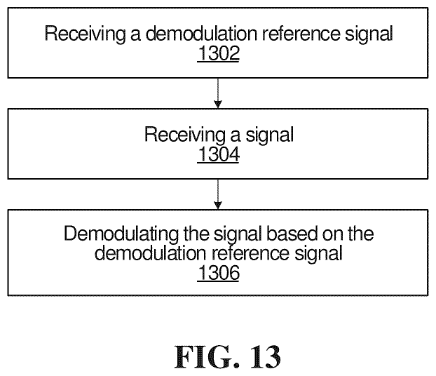

FIG. 13 shows a flowchart of a method according to embodiments of the disclosure. The method is performed by a network device. The network device may a base station or TRP, such as one of the TRPs 170 described above in respect of FIGS. 1-4. The network device may be in a radio access network (e.g., one of the radio access networks 130 described above in respect of FIGS. 1-4). In some examples, the network device may be the network device 502. The network device may be the network device 602. The network device may be network device 702.

In step 1302, the network device receives a DMRS transmitted by one or more first apparatus in two or more apparatus expected to have correlated channels. Each of the correlated channels are between a respective apparatus in the two or more apparatus and the network device.

The two or more apparatus may include, for example, the first apparatus 502 and the second apparatus 504. Thus, the channels may include the first channel and the second channel described above in respect of FIG. 5. The two or more apparatus may include, for example, two or more of: the discovery apparatus 604, the first responding apparatus 606 and the second responding apparatus 608. Thus, the channels may include two or more of the first, second and third channels described above in respect of FIG. 6. The two or more apparatus may be electronic devices, such as any of the electronic devices 130 described above in respect of FIGS. 1-4.

The channels may be expected to be correlated based on any of the factors described above in the description of the method 500. For example, the two or more apparatus may be co-located. The network device may determine that the channels are expected to be correlated. Alternatively, the determination may be made elsewhere (e.g., at one of the two or more apparatus).

In some examples, each of the two or more apparatus may be assigned a same group identifier (e.g., the common identifier discussed above). The DMRS may be associated (e.g., derivable from) the group identifier. Each of the two or more apparatus may be assigned a respective identifier specific to the apparatus (e.g., the apparatus-specific identifier described above). For example, the group of the two or more apparatus may be identified by the group identifier and a particular apparatus may be identified within the group by the apparatus-specific identifier.

In step 1304, the network device receives a signal transmitted by a second apparatus in the two or more apparatus. The signal may comprise data, for example. The one or more first apparatus comprise at least one apparatus that is different to the second apparatus.

In step 1306, the network device demodulates the signal based on the DMRS received in step 1302.

In some examples, the DMRS received in step 1302 is a same DMRS received from each of the two or more apparatus. Step 1306 may thus involve demodulating the signal based on the same DMRS (e.g., the combined signal from each of the apparatus).

In other examples, the DMRS received in step 1302 is a DMRS transmitted by a subset of the two or more apparatus. Step 1306 may thus involve demodulating the signal received from one apparatus using a DMRS received from another apparatus.

Although the method is described in respect of DMRS, the skilled person will appreciate that the method may, in general, be applied to other reference signals and, in particular to other uplink reference signals. In particular examples, the method may be adapted for a reference signal to be used for demodulation (e.g., which might or might not be DMRS).

In a further aspect, an apparatus (e.g., an entity) configured to perform the method is also provided. The apparatus may include a processor and a memory (e.g., a non-transitory processor-readable medium). The memory stores instructions (e.g., processor-readable instructions) which, when executed by a processor of an apparatus, cause the apparatus to perform the method. In another aspect, the memory may be provided (e.g., separate to the apparatus).

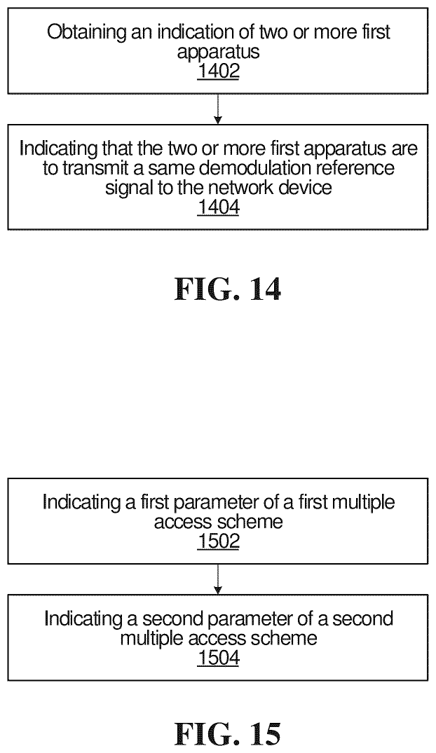

FIG. 14 shows a flowchart of a method according to embodiments of the disclosure.

In step 1402, the method involves obtaining an indication of two or more first apparatus, each of the two or more first apparatus having a respective first channel between the respective first apparatus and a network device.

The two or more first apparatus may include, for example, the first apparatus 502 and the second apparatus 504. Thus, the first channels may include the first channel and the second channel described above in respect of FIG. 5. The two or more first apparatus may include, for example, two or more of: the discovery apparatus 604, the first responding apparatus 606 and the second responding apparatus 608. Thus, the first channels may include two or more of the first, second and third channels described above in respect of FIG. 6. The two or more first apparatus may be electronic devices, such as any of the electronic devices 110 described above in respect of FIGS. 1-4.

The network device may a base station or TRP, such as one of the TRPs 170 described above in respect of FIGS. 1-4. The network device may be in a radio access network (e.g., one of the radio access networks 140 described above in respect of FIGS. 1-4). In some examples, the network device may be the network device 502. The network device may be the network device 602. The network device may be network device 702.

Obtaining the indication may involve receiving a message, such as a configuration request or an acknowledgement message, from the two or more first apparatus. For example, step 1402 may involve receiving the configuration requests 510a, 510b described above in respect of FIG. 5. In another example, step 1402 may involve receiving the response messages 612a, 612b described above in respect of FIG. 6.

In step 1404, the method involves indicating, based on a determination that the first channels are expected to be correlated, that the two or more first apparatus are to transmit a same DMRS to the network device. The method may further comprise determining that the first channels are expected to be correlated. The determination may be made using any of the techniques described above in respect of the method 500.

Indicating that the two or more first apparatus are to transmit a same DMRS may comprise instructing the two or more first apparatus to transmit the same DMRS. Thus, for example, step 1404 may comprise sending the same DMRS to the two or more first apparatus or sending an identifier of the same DMRS (e.g., the common identifier described above in the method 500) to the two or more first apparatus. In other examples, step 1404 may comprise indicating to one of the two or more first apparatus (e.g., a discovery apparatus such as the discovery apparatus 604) that a same DMRS is to be used by the two or more first apparatus. The same DMRS and/or the identifier may thus be sent to one of the two or more first apparatus.

The method may be performed by the network device. Alternatively, the method may be performed by a second apparatus (e.g., the discovery apparatus 604). The method may further comprise transmitting the same DMRS to the network device, based on a determination that a second channel between the second apparatus and the network device is expected to be correlated with at least one of the first channels.

Although the method is described in respect of DMRS, the skilled person will appreciate that the method may, in general, be applied to other reference signals and, in particular to other uplink reference signals. In particular examples, the method may be adapted for a reference signal to be used for demodulation (e.g., which might or might not be DMRS).

In a further aspect, an apparatus (e.g., an entity) configured to perform the method is also provided. The apparatus may include a processor and a memory (e.g., a non-transitory processor-readable medium). The memory stores instructions (e.g., processor-readable instructions) which, when executed by a processor of an apparatus, cause the apparatus to perform the method. In another aspect, the memory may be provided (e.g., separate to the apparatus).

FIG. 15 shows a flowchart of a method 1500 according to embodiments of the disclosure.

The method 1500 involves, in step 1502, indicating, to a first apparatus, a first parameter of a first multiple access scheme. The first multiple access scheme may be any suitable multiple access scheme, such as any of those described above. For example, the first multiple access scheme may comprise one or more of: a code domain multiple access scheme, a power domain multiplexing scheme (also referred to as power division multiple access), a spreading code-based multiple access scheme, a signature-based multiple access scheme and a hopping sequence-based multiple access scheme. The first multiple access scheme is for transmissions by the first apparatus and a second apparatus to a network device.

The network device may a base station or TRP, such as one of the TRPs 170 described above in respect of FIGS. 1-4. The network device may be in a radio access network (e.g., one of the radio access networks 120 described above in respect of FIGS. 1-4). In some examples, the network device may be the network device 502. The network device may be the network device 602. The network device may be network device 702.

The first apparatus and the second apparatus may be electronic devices, such as any of the electronic devices 150 described above in respect of FIGS. 1-4. The first apparatus and the second apparatus may be the first and second electronic device 704, 706 described above in respect of FIG. 7. The first apparatus and the second apparatus may be the first apparatus 502 and the second apparatus 504. The first apparatus and the second apparatus may be, for example, two of: the discovery apparatus 604, the first responding apparatus 606 and the second responding apparatus 608.

A first channel between the first apparatus and the network device is expected to be correlated with a second channel between the second apparatus and the network device. The first and second channels may be expected to be correlated based on any of the factors described above in the description of the method 500. For example, the first and second apparatus may be co-located. The method 1500 may further involve determining that the channels are expected to be correlated.

The first channel and the second channel may be the first channel and the second channel described above in respect of FIG. 5. The first channel and the second channel may be any two of the first, second and third channels described above in respect of FIG. 6.

The method 1500 further involves, in step 1504, indicating, to a third apparatus, a second parameter of a second multiple access scheme for transmissions by the third apparatus to the network device. The third apparatus may be the third apparatus 508 described above in respect of FIG. 5. A channel between the third apparatus and the network device might not be correlated with one or both of the first channel and the second channel.

The method 1500 may be performed by the network device. Alternatively, the method may be performed by the second apparatus. The method 1500 may further comprise transmitting a signal to the network device according to the second multiple access scheme.

In a further aspect, an apparatus (e.g., an entity) configured to perform the method 1500 is also provided. The apparatus may include a processor and a memory (e.g., a non-transitory processor-readable medium). The memory stores instructions (e.g., processor-readable instructions) which, when executed by a processor of an apparatus, cause the apparatus to perform the method 1500. In another aspect, the memory may be provided (e.g., separate to the apparatus).

The present disclosure thus provides methods in which apparatus which are expected to have correlated channels may be assigned one or more of: a same DMRS, a same multiple access scheme, a common identifier and a common configuration (e.g., which may include a same DMRS, a common identifier and/or a same multiple access scheme). These apparatuses are also referred to as intra-UE. In general, the apparatus referred to herein as having correlated channels may be any apparatus which have or are expected to have similar channels. Thus, the channels between the respective apparatus and the network device may be within a threshold difference or variation of one another. In general, the skilled person will appreciate that there are many ways in which apparatus having similar channels may be identified (e.g., based on channel correlation, location, channel distance etc.). Thus, in general, two or more apparatus may be determined to be intra-UEs based on one or more of these factors. Other apparatus may have or be expected to have sufficiently different channels and thus might not be determined to be intra-UEs.

### CLOSING PARAGRAPHS

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Numerous modifications and variations of the present disclosure are possible in light of the above teachings. It is therefore to be understood that within the scope of the appended claims, the disclosure may be practiced otherwise than as specifically described herein.

1. A method performed by a network device, the method comprising:
receiving a demodulation reference signal transmitted by one or more first apparatuses in a plurality of apparatuses, the plurality of apparatuses having correlated channels, each of the correlated channels being between a respective apparatus in the plurality of apparatuses and the network device;
receiving a signal transmitted by a second apparatus in the plurality of apparatuses; and
demodulating the signal based on the demodulation reference signal, wherein the one or more first apparatuses comprise at least one apparatus different from the second apparatus.

2. The method of claim 1, wherein the plurality of apparatuses is determined to have the correlated channels based on one or more of:
respective locations of the plurality of apparatuses;
a channel correlation estimate for a first channel in the correlated channels and a second channel in the correlated channels;
a measurement of a channel between one of the plurality of apparatuses and another of the plurality of apparatuses;
a difference in a first measurement of the first channel and a second measurement of the second channel; or
a comparison of the channel correlation estimate to a threshold.

3. The method of claim 1, wherein the receiving the demodulation reference signal comprises:
receiving, from each of the plurality of apparatuses, a same demodulation reference signal.

4. The method of claim 1, wherein the receiving the demodulation reference signal comprises:
receiving the demodulation reference signal transmitted by a subset of the plurality of apparatuses on behalf of the plurality of apparatuses.

5. The method of claim 1, further comprising: for each apparatus in the plurality of apparatuses:
receiving a respective transmission from the respective apparatus; and
determining a respective identifier specific to the respective apparatus based on one or more of:
a codeword of the respective transmission,
a modulation scheme used for the respective transmission, or
a power of the respective transmission.

6. A method performed by a first apparatus, the method comprising:
transmitting a demodulation reference signal to a network device, the demodulation reference signal for demodulating a signal transmitted by a second apparatus to the network device, the first apparatus and the second apparatus having correlated channels including a first channel between the first apparatus and the network device and a second channel between the second apparatus and the network device.

7. The method of claim 6, wherein the first apparatus and the second apparatus are determined to have the correlated channels based on one or more of:
respective locations of the first apparatus and the second apparatus;
a channel correlation estimate for the first channel and the second channel;
a measurement of a channel between the first apparatus and the second apparatus;
a difference in a first measurement of the first channel and a second measurement of the second channel; or
a comparison of the channel correlation estimate to a threshold.

8. The method of claim 6, wherein the demodulation reference signal transmitted by the first apparatus is a same demodulation reference signal transmitted by the second apparatus.

9. The method of claim 6, wherein the demodulation reference signal transmitted by the first apparatus is transmitted on behalf of the second apparatus.

10. The method of claim 6, wherein each of the first apparatus and the second apparatus is assigned a same group identifier, and the demodulation reference signal is associated with the same group identifier.

11. An apparatus comprising:
a memory storing instructions; and
at least one processor caused, by executing the instructions, to cause the apparatus to:
receive a demodulation reference signal transmitted by one or more first apparatuses in a plurality of apparatuses, the plurality of apparatuses having correlated channels, each of the correlated channels being between a respective apparatus in the plurality of apparatuses and a network device, the network device comprising the apparatus;
receive a signal transmitted by a second apparatus in the plurality of apparatuses; and
demodulate the signal based on the demodulation reference signal, wherein the one or more first apparatuses comprise at least one apparatus different from the second apparatus.

12. The apparatus of claim 11, wherein the plurality of apparatuses is determined to have the correlated channels based on one or more of:
respective locations of the plurality of apparatuses;
a channel correlation estimate for a first channel in the correlated channels and a second channel in the correlated channels;
a measurement of a channel between one of the plurality of apparatuses and another of the plurality of apparatuses;
a difference in a first measurement of the first channel and a second measurement of the second channel; or
a comparison of the channel correlation estimate to a threshold.

13. The apparatus of claim 11, wherein the processor further causes the apparatus to receive the demodulation reference signal by:
receiving, from each of the plurality of apparatuses, a same demodulation reference signal.

14. The apparatus of claim 11, wherein the processor further causes the apparatus to receive the demodulation reference signal by:
receiving the demodulation reference signal transmitted by a subset of the plurality of apparatuses on behalf of the plurality of apparatuses.

15. The apparatus of claim 11, wherein the processor further causes the apparatus to, for each apparatus in the plurality of apparatuses:
receive a respective transmission from the respective apparatus; and
determine a respective identifier specific to the respective apparatus based on one or more of:
a codeword of the respective transmission,
a modulation scheme used for the respective transmission, or
a power of the respective transmission.

16. A first apparatus comprising:
a memory storing instructions; and
at least one processor caused, by executing the instructions, to cause the first apparatus to:
transmit a demodulation reference signal to a network device, the demodulation reference signal for demodulating a signal transmitted by a second apparatus to the network device, the first apparatus and the second apparatus having correlated channels including a first channel between the first apparatus and the network device and a second channel between the second apparatus and the network device.

17. The first apparatus of claim 16, wherein the first apparatus and the second apparatus are determined to have the correlated channels based on one or more of:
respective locations of the first apparatus and the second apparatus;
a channel correlation estimate for the first channel and the second channel;
a measurement of a channel between the first apparatus and the second apparatus;
a difference in a first measurement of the first channel and a second measurement of the second channel; or
a comparison of the channel correlation estimate to a threshold.

18. The first apparatus of claim 16, wherein the demodulation reference signal transmitted by the first apparatus is a same demodulation reference signal transmitted by the second apparatus.

19. The first apparatus of claim 16, wherein the demodulation reference signal transmitted by the first apparatus is transmitted on behalf of the second apparatus.

20. The first apparatus of claim 16, wherein each of the first apparatus and the second apparatus is assigned a same group identifier, and the demodulation reference signal is associated with the same group identifier.
